(19) United States
(12) Patent Application Publication
(10) Pub. No.: US 2023/0397090 A1
(43) Pub. Date: Dec. 7, 2023

(54) TARGETED SI UPDATE INDICATION

(71) Applicant: QUALCOMM Incorporated, San Diego, CA (US)

(72) Inventors: Navid ABEDINI, Basking Ridge, NJ (US); Tao LUO, San Diego, CA (US); Wanshi CHEN, San Diego, CA (US)

(21) Appl. No.: 17/805,199

(22) Filed: Jun. 2, 2022

(51) Int. Cl. H04W 48/12; H04W 72/14; H04W 72/12

(52) U.S. Cl. CPC H04W 48/12; H04W 72/14; H04W 72/1289

(57) ABSTRACT

A network node may transmit a targeted SI update indication for the one or more subsets of wireless devices or for the subset of directions, the targeted SI update indication including a downlink grant of the at least one SI update associated with the one or more subsets of wireless devices or the subset of directions. A network device of the subset of network devices may receive the targeted SI update indication and receive the at least one SI update associated with the one or more subsets of wireless devices. In one aspect, the targeted SI update indication is for the subset of directions. In another aspect, the targeted SI update indication includes an indicator that the targeted SI update indication is associated with the one or more subsets of wireless devices.

### TECHNICAL FIELD

The present disclosure relates generally to communication systems, and more particularly, to a method of wireless communication including a targeted system information (SI) update indication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be configured to receive a targeted system information (SI) update indication for one or more subsets of wireless devices including the wireless device from a network node, the targeted SI update indication including a downlink grant of at least one SI update associated with the one or more subsets of wireless devices of a set of wireless devices. The apparatus may also be configured to receive the at least one SI update from the network node based on the downlink grant of the at least one SI update associated with the one or more subsets of wireless devices including the wireless device.

In an aspect of the disclosure, a method, a computer-readable medium, and an apparatus are provided. The apparatus may be configured to obtain at least one update of a SI associated with one or more subsets of wireless devices among a set of wireless devices associated with the network node or a subset of directions from the network node. The apparatus may also be configured to output for transmission a targeted SI update indication for the one or more subsets of wireless devices among the set of wireless devices associated with the network node or for the subset of directions, the targeted SI update indication including a downlink grant of the at least one SI update associated with the one or more subsets of wireless devices or the subset of directions.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example IAB network.

FIG. 5 is a diagram illustrating an example IAB network and components thereof.

FIG. 6 is a diagram illustrating an example connection for an IAB network.

FIG. 7 is a diagram of a targeted SI update indication and associated DCI of a method of wireless communication.

FIG. 8 is a diagram of a targeted SI update indication and associated DCI of a method of wireless communication.

FIG. 9 is a diagram of a targeted SI update indication and associated DCI of a method of wireless communication.

FIG. 10 is a call-flow diagram of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a diagram illustrating an example of a hardware implementation for an example apparatus and/or network entity.

FIG. 16 is a diagram illustrating an example of a hardware implementation for an example network entity.

FIG. 17 is a diagram illustrating an example of a hardware implementation for an example network entity.

### DETAILED DESCRIPTION

A network node may broadcast system information (SI) update for all the network devices and the network devices may wake up to receive and decode the SI update indication. Based on some aspects of the current disclosure, if the SI update may be directed to a subset of network devices, the network node may transmit a targeted SI update indication to the subset of network devices, and the subset of network devices may receive the targeted SI update based on the targeted SI update indication. Because the network devices other than the one or more subsets of network devices do not need to receive the targeted SI update, the overall power consumption for transmitting the targeted SI update indication and the targeted SI update may be reduced.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

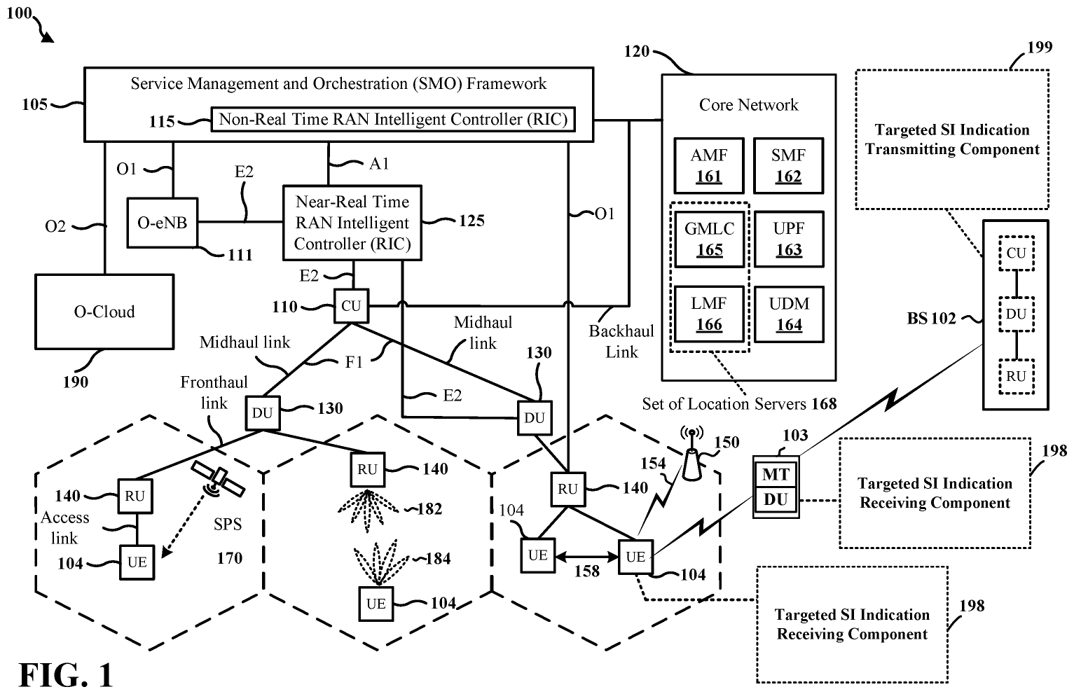

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The wireless communication system and access network 100 may include an integrated access and backhaul (IAB) network that includes multiple cells in communication with each other to provide an access network and a backhaul network to a core network such as core network 120 or Evolved Packet Core (EPC). The core network 120 may be a 5G Core (5GC), a core network that supports new radio (NR) communication or another type of core network. The IAB network may include one or more IAB nodes 103. The IAB nodes may exchange communication with other IAB nodes 103, with a base station 102, and/or with UEs 104.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a targeted SI indication receiving component 198 configured to receive a targeted SI update indication for one or more subsets of wireless devices including the wireless device from a network node, the targeted SI update indication including a downlink grant of at least one SI update associated with the one or more subsets of wireless devices of a set of wireless devices, and receive the at least one SI update from the network node based on the downlink grant of the at least one SI update associated with the one or more subsets of wireless devices including the wireless device. In certain aspects, the base station 102 may include a targeted SI indication transmitting component 199 configured to obtain at least one update of a SI associated with one or more subsets of wireless devices among a set of wireless devices associated with the network node or a subset of directions from the network node, and output for transmission a targeted SI update indication for the one or more subsets of wireless devices among the set of wireless devices associated with the network node or for the subset of directions, the targeted SI update indication including a downlink grant of the at least one SI update associated with the one or more subsets of wireless devices or the subset of directions.

Although the following description may be focused on 5G NR, the concepts described herein may be applicable to other similar areas, such as LTE, LTE-A, CDMA, GSM, and other wireless technologies.

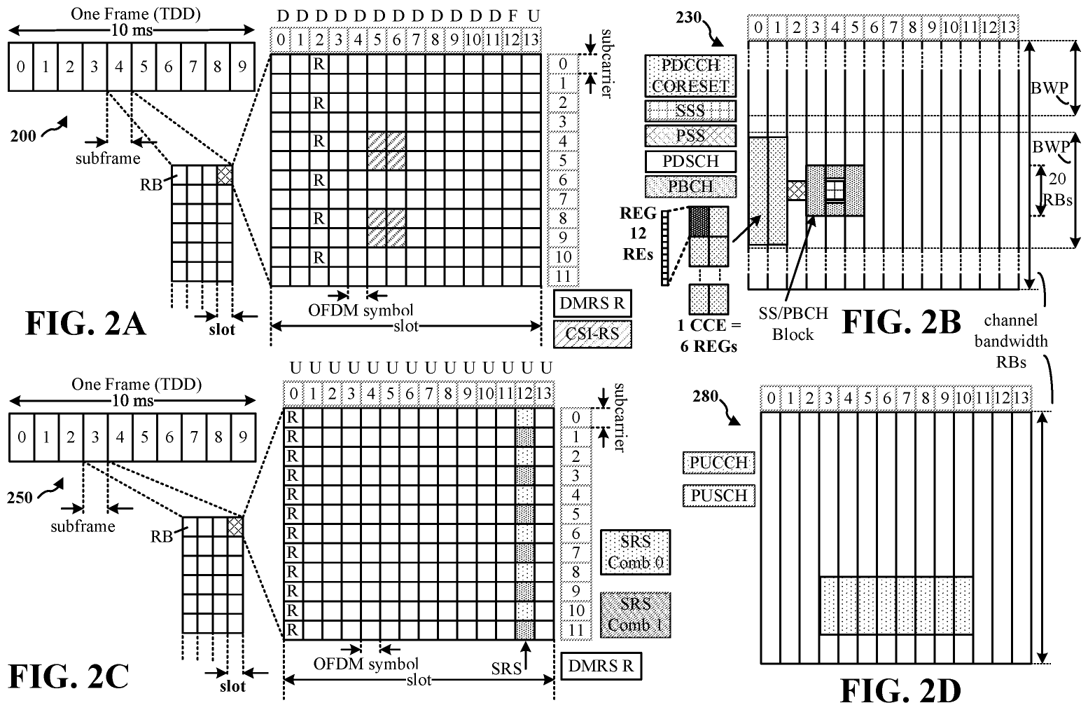

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

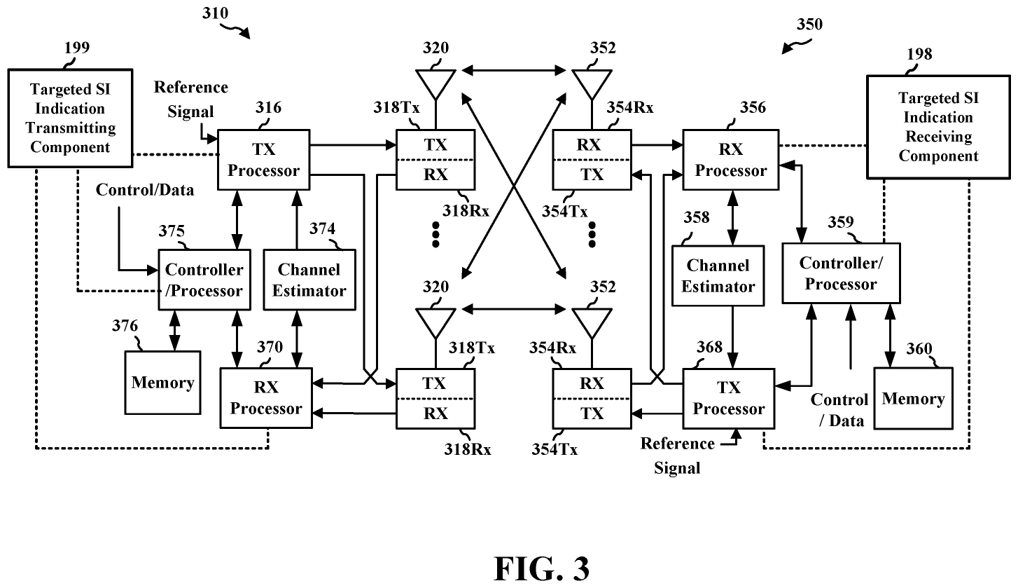

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the targeted SI indication receiving component 198 of FIG. 1. At least one of the TX processor 316, the RX processor 370, and the controller/processor 375 may be configured to perform aspects in connection with the targeted SI indication transmitting component 199 of FIG. 1.

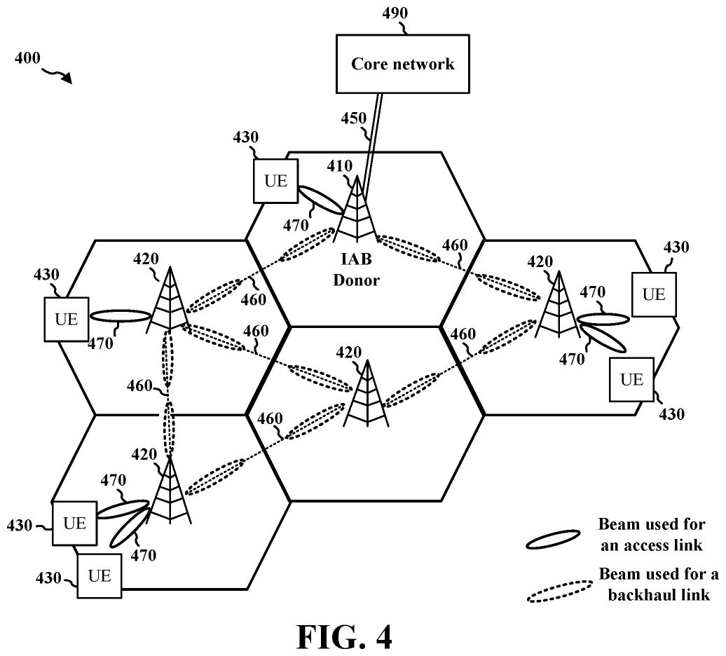

FIG. 4 is a diagram illustrating an IAB network 400. The IAB network provides access network functionality between access nodes (ANs) and other ANs/UEs, and backhaul network functionality between ANs. The ANs include IAB-donors, which have a wireline connection to the core network, and IAB-nodes, which operate wirelessly and relay traffic to/from IAB-donors through one or more AN hops. The IAB ANs share resources between the access and backhaul. That is, the resources used for access communication between the ANs and ANs/UEs are also used for backhaul communication between the ANs.

The IAB network 400 may include an anchor node (that may be referred to herein as an “IAB donor”) 410 and access nodes (that may be referred to herein as “IAB nodes”) 420. The IAB donor 410 may be a base station, such as a gNB or eNB, and may perform functions to control the IAB network 400. The IAB nodes 420 may comprise L2 relay nodes, etc. Together, the IAB donor 410 and the IAB nodes 420 share resources to provide an access network and a backhaul network to core network 490. For example, resources may be shared between access links and backhaul links in the IAB network.

UEs 430 interface with the IAB nodes 420 or the IAB donor 410 through access links 470. The IAB nodes 420 communicate with each other and with the IAB donor 410 through backhaul links 460. The IAB donor 410 is connected to the core network 490 via a wireline backhaul link 450. UEs 430 communicate with the core network by relaying messages through their respective access link 470 to the IAB network 400, which then may relay the message through backhaul links 460 to the IAB donor 410 to communicate to the core network through the wireline backhaul link 450. Similarly, the core network may communicate with a UE 430 by sending a message to the IAB donor 410 through the wireline backhaul link 450. The IAB donor 410 sends the message through the IAB network 400 via backhaul links 460 to the IAB node 420 connected to the UE 430, and the IAB node 420 sends the message to the UE 430 via the access link 470.

Each IAB node, e.g., including IAB donor 410 and each IAB node 420, may use a PCI value. The PCI value may serve as an identifier for that IAB donor 410 or IAB node 420. The PCI value may be used to determine a scrambling sequence that is applied to physical signals and/or channels that are transmitted by a particular IAB node. For example, a PSS and/or the SSS transmitted by the respective IAB donor 410 or IAB node 420 may be scrambled using a scrambling sequence that is based on the PCI used by the respective IAB node.

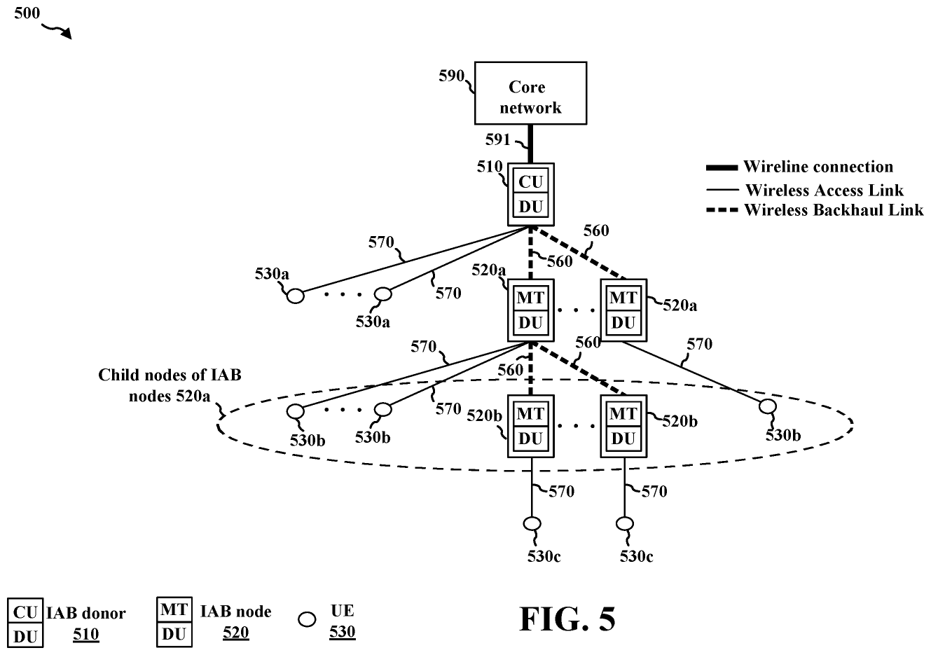

FIG. 5 illustrates a second diagram illustrating an IAB network 500 and components thereof. The IAB network 500 includes an IAB donor 510 and IAB nodes 520. The IAB nodes, as well as the IAB donor, may provide wireless access links to UEs 530.

The IAB donor 510 may be considered a root node of the tree structure of the IAB network 500. The IAB donor 510 may be connected to the core network 590 via a wired connection 591. The wired connection may comprise, e.g., a wireline fiber. The IAB donor 510 may provide a connection to one or more IAB nodes 520a. The IAB nodes 520a may each be referred to as a child node of the IAB donor 510. The IAB donor 510 may also provide a connection to one or more UE 530a, which may be referred to as a child UE of IAB donor 510. The IAB donor 510 may be connected to its child IAB nodes 520a via backhaul links 560, and may be connected to the child UEs 530a via access links 570. The IAB nodes 520a that are children nodes of IAB donor 510 may also have one or more IAB nodes 520b and/or one or more UEs 530b as children. For example, IAB nodes 520b may further connect to child nodes and/or child UEs. FIG. 5 illustrates IAB nodes 520b providing an access link to UEs 530c, respectively.

The IAB donor 510 may include a central unit (CU) and a distributed unit (DU). The central unit CU may provide control for the IAB nodes 520a, 520b in the IAB network 500. For example, the CU may control the IAB network 500 through configuration. The CU may perform RRC/PDCP layer functions. The IAB donor 510 may further include a DU that performs scheduling. For example, the DU may schedule resources for communication by the child IAB nodes 520a and/or UEs 530a of the IAB donor 510. The DU holds radio link control (RLC), media access control (MAC), a physical (PHY) layer functions.

The IAB nodes 520a, 520b may include a mobile termination (MT) and a DU. The IAB node is an L2 relay node. The MT of IAB node 520a may operate as a scheduled node, scheduled similar to a UE 530a by the DU of the parent node, e.g., IAB donor 510. The MT of IAB node 520b may operate as a scheduled node of parent node 520a. The DU may schedule the child IAB nodes 520b and UEs 530b of the IAB node 520a. As an IAB node may provide a connection to an IAB node that in turn provides a connection for another IAB node. The pattern of a parent IAB node comprising a DU that schedules a child IAB node/child UE may continue to more connections that illustrated in FIG. 5.

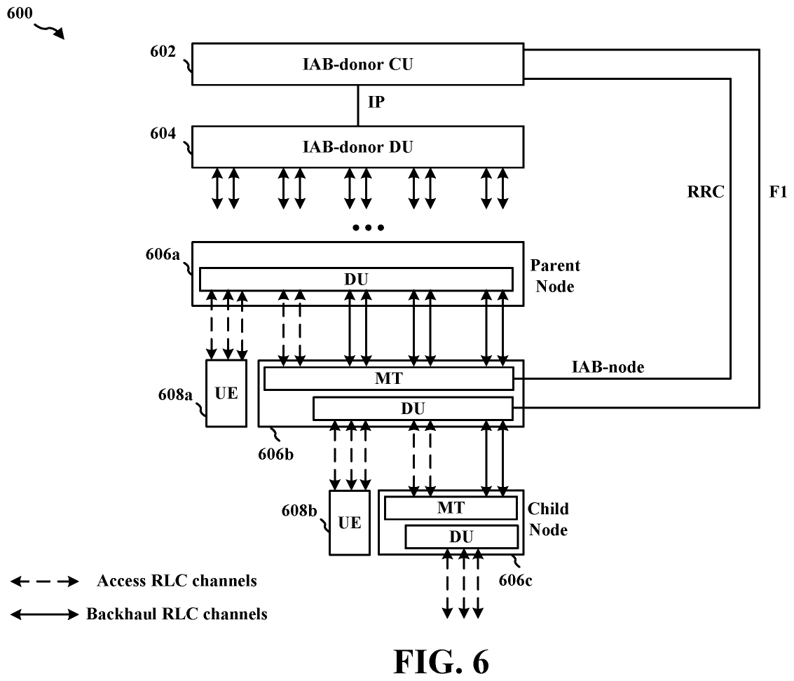

FIG. 6 is a diagram 600 illustrating RLC channels in an IAB network. As discussed supra, the IAB network provides both access network functionality and backhaul network functionality. The IAB network includes an IAB donor with a CU 602 and DU 604 Per the access network functionality, IAB ANs 606a, 606b, and 606c may communicate with other UEs 608a and 608b and/or MTs of other IAB ANs through access RLC channels. Per the backhaul network functionality, IAB ANs 606a, 606b, and 606c may route traffic to other ANs (e.g., 606a, 606b, and 606c) through backhaul RLC channels. Access RLC channels include UE-to-DU/DU-to-UE, carrying PDCP for RRC or data radio bearers (DRBs), and MT-to-DU/DU-to-MT, carrying PDCP for RRC (or DRBs). Backhaul RLC channels include MT-to-DU/DU-to-MT, carrying backhaul adaptation protocol (BAP) messages for backhauling access traffic.

In some aspects, if any of the system information (SI) is updated, an SI update indication (e.g., via a short message scrambled by a paging radio network temporary identifier (P-RNTI)) may be broadcasted to each device (e.g., network devices) in a coverage area of a network node, such as a base station or IAB node. The SI update may be broadcast in each transmission direction from the network node. As an example, the network node may transmit the SI update may in a downlink control information format 1_0 (DCI 1_0) scrambled with the P-RNTI. The DCI 1_0 may include a short message indicator represented by a 2-bits length bit-field, a short message represented by an 8-bits length bit-field, a PDSCH grant, and a reserved bit represented by a 6-bits length bit-field.

Table 1 shows an example mapping between the value of the short message indicator and the short message indication.

TABLE 1

| Bit | |
|---|---|
| Value | Short Message indicator |
| 00 | Reserved |
| 01 | Only scheduling information for Paging is present in the DCI |
| 10 | Only short message is present in the DCI |
| 11 | Both scheduling information for Paging and short message are |
| | present in the DCI |

Table 2 shows an example mapping between bit-fields of the short message and the short message.

TABLE 2

| Bit- | |
|---|---|
| field | Short Message |
| 1 | systemInfoModification - If set to 1: indication of a BCCH |
| | modification other than SIB6, SIB7, and SIB8. |
| 2 | etwsAndCmasIndication - If set to 1: indication of an ETWS |
| | primary notification and/or an ETWS secondary notification |
| | and/or a CMAS notification. |
| 3 | stopPagingMonitoring - This bit can be used for shared spectrum |
| | channel access and if nrofPDCCH-MonitoringOccasionPerSSB- |
| | InPO is present. |
| | If set to 1: indication that the UE may stop monitoring PDCCH |
| | occasion(s) for paging in this Paging Occasion |
| 4-8 | Reserved |

Based on an update of at least a part of the system information (SI), the network node may transmit or broadcast an SI update indication in the DCI 1_0 to the set of network devices. Here, the set of network devices receiving the SI update may include a user equipment (UE) that receives the SI update from a base station and/or an IAB node (e.g., a child-node that receives the SI update from a parent IAB node). The SI update indication notifies the set of network devices of the SI update, and provides the scheduling information (e.g., grant information of PDSCH carrying the SI update) for the set of network devices, and the set of network devices may receive the SI update based on the SI update indication. Here, the PDSCH associated with the grant information of the DCI 1_0 may carry the paging message, and may be referred to as the paging PDSCH. Because the network node may broadcast the SI update indication and the network node may wake up to receive and decode the SI update indication, communication of the SI update for all the wireless devices may consume a relatively large amount of energy for the set of network devices (e.g., the UEs or child IAB nodes), as well as at the network node (e.g., the base station).

In some examples, the updated SI may be relevant to a subset of some of the wireless devices (e.g., child-nodes of an IAB node and not to UEs served by an IAB node). In one example, some SI included in SIB #1 (SIB1) from a parent IAB node or base station may include parameters for IAB-MTs, which may not be relevant for UEs served by the parent IAB node or base station. For example, the SIB1 may include parameters for backhaul (BH) random access channel (RACH) configuration, which may be irrelevant for the UEs.

In another example, more new parameters may be added to SIB1 for a subset of UEs. As an example, a subset of UEs may support an additional capability (e.g., and may be referred to as non-legacy UEs), while another set of UEs may not support the additional capability (and may be referred to as legacy UEs). That is, some SI of new parameters included in the SIB1 may be targeted for a subset of UEs that may support certain features, and the UEs that do not support one or more of the features may not understand the new parameters included in the SIB1. For example, new parameters may be added to SIB1 in the context of network energy savings (NES) feature, and the SI configuration or update of the new parameters associated with the NES may be relevant to UEs that may support the NES feature.

In another example, some parameters may be beam-specific (e.g., transmit-receive point (TRP)-specific). That is, some parameters added to the SIB1 may be specific to a particular TRP or to a particular transmit and/or receive beam, which may be relevant to a direction with respect to the network node. The SI configuration and update may be relevant to the direction of the network device with respect to the network node.

Accordingly, the SI update indication and associated SI update may be targeted to a subset of network devices among the set of network devices. That is, in case the SI update is targeted for or associated with a subset of network devices but not targeted for or associated with other network devices of the set of network devices, the network node may notify that the SI update indication is targeted for the subset of network devices, and the subset of network devices may receive the SI update based on the SI update indication, while the other network devices may not wake up for the targeted SI update procedure. The network node and the set of network devices may reduce the overall power consumption by transmitting the targeted SI update indication and the targeted SI update.

In one aspect, the paging message may be separately configured for the UEs and the IAB-MTs. That is, a set of network devices (or users) may be grouped into two or more groups of users (e.g., two or more subsets of devices), and the network node may have the flexibility of paging a first (default) group of users, and a second group of users (configurable). The two groups may be configured with different types, specifications, or services.

In one example, a BH specific P-RNTI may be configured for IAB-MTs, which may be configured differently from the P-RNTI for paging UEs. In another example, at least one reserve bit in the short message may be used to notify the IAB-MTs about an SI update, without affecting the UEs. In another example, a BH-specific parameter (e.g., pagingSearchSpace_IAB) may be configured for the BH-specific search space for paging, which may be configured separately from the “pagingSearchSpace” parameter configured for the UEs. In another example, a BH-specific parameter (e.g., nAndPagingFrameOffset_IAB) may be configured for paging frame offset, which may be configured separately from the “nAndPagingFrameOffset” parameter for the UEs. Here, the BH-specific parameters may be separately configured in the same SIB1 or another SIB/RRC message.

In another aspect, the SI update indication may be carried in a paging PDSCH, and the paging PDSCH may also carry include additional information. The paging PDSCH may refer to the PDSCH carrying the paging message. The paging PDSCH may carry at least one or a combination of the following indications of the SI update; (1) an indication of the SI update indication, (2) an indication of which SIB has been updated, (3) an indication of which IE has been updated, or (4) the updated parameters directly provided in the PDSCH payload.

In some aspects, a targeted SI update indication may be provided by the network node to a subset of network devices (e.g., UE, child IAB nodes, etc.), and the subset of network devices associated with the targeted SI update indication may be notified of the SI update. Because the network node may not transmit the SI update to the other network devices of the set of network devices that are not associated with the SI update, and the other network devices (e.g., to which the SI update does not pertain) may not wake up to receive the targeted SI update, the other set of network devices and/or the network node may reduce the overall power consumption.

In one aspect, the targeted SI update indication may be transmitted only to a subset of relevant directions. The SI update may include parameters that may be beam-specific or associated to the location of the network device with respect to the network node. For example, the SI update may be targeted for a subset of TRPs or IAB-MTs that are located within a certain physical location in a subset of relevant directions with respect to the network node. Accordingly, the targets SI update indication may be targeted for a subset of wireless devices (e.g., the UEs or the IAB-MTs) located within the certain physical location in the subset of directions with respect to the network node. The network may transmit the SI update indication to the subset of directions with respect to the network node to target the subset of wireless devices located in the subset of directions with respect to the network node.

In another aspect, the targeted SI update indication may be sent to one or more subsets of relevant child-nodes (e.g., the set of network devices). That is, the targeted SI update indication may be configured to indicate the one or more subsets of network devices that are associated with the targeted SI update. Various implementation may be provided to indicate the one or more subsets of network devices that are associated with the targeted SI update. Based on the indication of the one or more subsets of network devices that are associated with the targeted SI update, the network device may transmit the SI update to the one or more subsets of network devices that are associated with the targeted SI update. The targeted SI update may support more than or equal to 2 subsets of child-nodes (wireless devices).

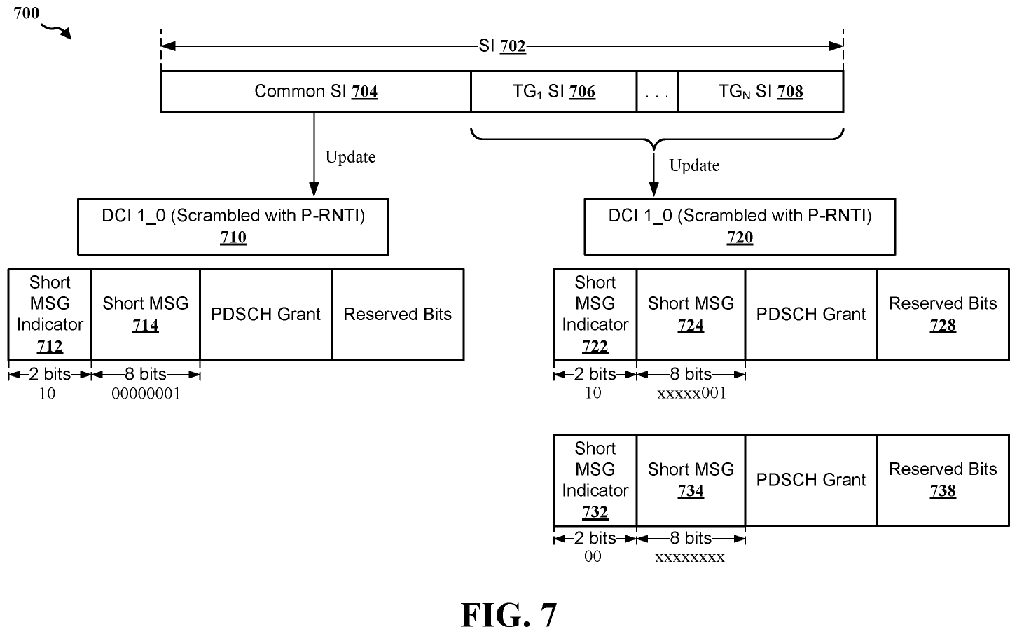

FIG. 7 is a diagram 700 of a targeted SI update indication and associated DCI of a method of wireless communication. An SI 702 of a network node may include SI parameters or IEs of a set of wireless devices communicating with the network node. The SI 702 may include a common SI 704 and a set of target group (TG) SIs (or TG IE blocks) including a first TG SI 706 to N^{th} TG SI 708. The first TG SI 706 may be associated with a first subset of wireless devices, and the N^{th} TG SI 708 may be associated with a N^{th} subset of wireless devices. The network node may detect an update in the SI 702, and determine to send the SI update to at least one wireless device of the set of wireless devices. The network node may obtain the SI update in the common SI 704, and the network node may be configured to transmit a common SI update indication to the set of network devices. The network node may obtain the SI update in the at least one TG SI, and the network node may be configured to transmit a targeted SI update indication targeted to the subset of wireless devices associated with the at least one TG SI with the SI update.

The network node may obtain the SI update in the common SI 704, and the network node may be configured to transmit a common SI update indication to the set of network devices. The common SI update indication may be transmitted in a common DCI 1_0 710 scrambled with the P-RNTI, and the common DCI 1_0 710 may include a short message indicator 712, a short message 714, a PDSCH grant, and reserved bits. For example, the short message indicator 712 may have the bit value of 10 indicating that the short message 714 is present in the DCI but not the scheduling information for paging, and the short message 714 may have the first bit-field value of 1 indicating that SI update is for the BCCH modification other than SIB6, SIB7, and SIB8.

In some aspects, the network node may obtain the SI update in the at least one TG SI including the first TG SI 706 to the N^{th} TG SI 708, and the network node may transmit the targeted SI update indication targeted to one or more subsets of wireless devices associated with the at least one TG SI with the SI update. The targeted SI update indication may be transmitted in a targeted DCI 1_0 720 scrambled with the P-RNTI, and at least one bit-field of the targeted DCI 1_0 720 may indicate that the targeted DCI 1_0 720 is targeted to the one or more subsets of wireless devices, and identify the one or more subsets of wireless devices associated with the targeted SI update indicated by the targeted DCI 1_0 720.

In one aspect, the reserved bit-fields of the short message 724 may represent a bitmap configured to identify the one or more subsets of wireless devices associated with the targeted SI update indicated by the targeted DCI 1_0 720, and a presence of the bit value in the reserved bit-fields of the short message 724 may indicate that the targeted DCI 1_0 720 is targeted to the one or more subsets of wireless devices. The short message indicator 722 may have the bit value of 10 indicating that the short message 714 is present in the DCI but not the scheduling information for paging, and the first bit-field of the short message 714 may have the bit value of 1 indicating that SI update is for the BCCH modification other than SIB6, SIB7, and SIB8. The five (5) reserved bit-fields (e.g., the bit fields 4, 5, 6, 7, and 8) of the short message 724 may represent the bitmap, each bit of the bitmap being respectively mapped to up to five (5) subsets of wireless devices, and support up to five (5) subsets of wireless devices.

In one example, the at least one TG SI may include five (5) TG SIs, including the first TG SI 706 to the fifth TG SI 708, respectively associated with a first subset of wireless devices to a fifth subset of wireless devices. The bit field 4 of the short message 724 may be mapped to the first subset of wireless devices associated with the first TG SI 706, and the bit field 8 of the short message 724 may be mapped to the fifth subset of wireless devices associated with the fifth TG SI 708. For example, the short message 724 may have the bit value of 10001001, indicating that the network node may transmit the SI update of the first TG SI 706 and the fifth TG SI 708 respectively associated with the first subset of wireless devices and the fifth subset of wireless devices.

Furthermore, some of the reserved bits 728 may also be configured to support more than five (5) subsets of wireless devices. For example, two (2) bit-fields of the reserved bits 728 may be configured for the target SI update indication, and the targeted DCI 1_0 702 may support up to seven (7) subsets of wireless devices using the five (5) reserved bit-fields of the short message 724 and the two (2) bit-fields of the reserved bits 728.

In another aspect, the reserved bit value (e.g., the bit value of 00) of the short message indicator 732 may be configured to indicate that the targeted DCI 1_0 730 is targeted to the one or more subsets of wireless devices, and the short message 734 as a whole may be configured to identify the one or more subsets of wireless devices associated with the targeted SI update indicated by the targeted DCI 1_0 730. The short message indicator 732 may have a bit-field value of 00 to indicate that the targeted DCI 1_0 730 is targeted to the one or more subsets of wireless devices, not for the whole set of wireless devices. The eight bit-fields (e.g., the bit fields 1, 2, 3, 4, 5, 6, 7, and 8) of the short message 734 may represent the bitmap, each bit of the bitmap being respectively mapped to up to eight (8) subsets of wireless devices, and support up to eight (8) subsets of wireless devices.

In one example, the at least one TG SI may include eight (8) TG SIs, including the first TG SI 706 to the eighth TG SI 708, respectively associated with a first subset of wireless devices to an eighth subset of wireless devices. The bit field 1 of the short message 734 may be mapped to the first subset of wireless devices associated with the first TG SI 706, and the bit field 8 of the short message 734 may be mapped to the eighth subset of wireless devices associated with the eighth TG SI 708. For example, the short message 734 may have the bit value of 10000001, indicating that the network node may transmit the SI update of the first TG SI 706 and the eighth TG SI 708 respectively associated with the first subset of wireless devices and the eighth subset of wireless devices.

Furthermore, some of the reserved bits 738 may also be configured to support more than eight (8) subsets of wireless devices. For example, two (2) bit-fields of the reserved bits 738 may be configured for the target SI update indication, and the targeted DCI 1_0 702 may support up to ten (10) subsets of wireless devices using the eight (8) reserved bit-fields of the short message 734 and the two (2) bit-fields of the reserved bits 738.

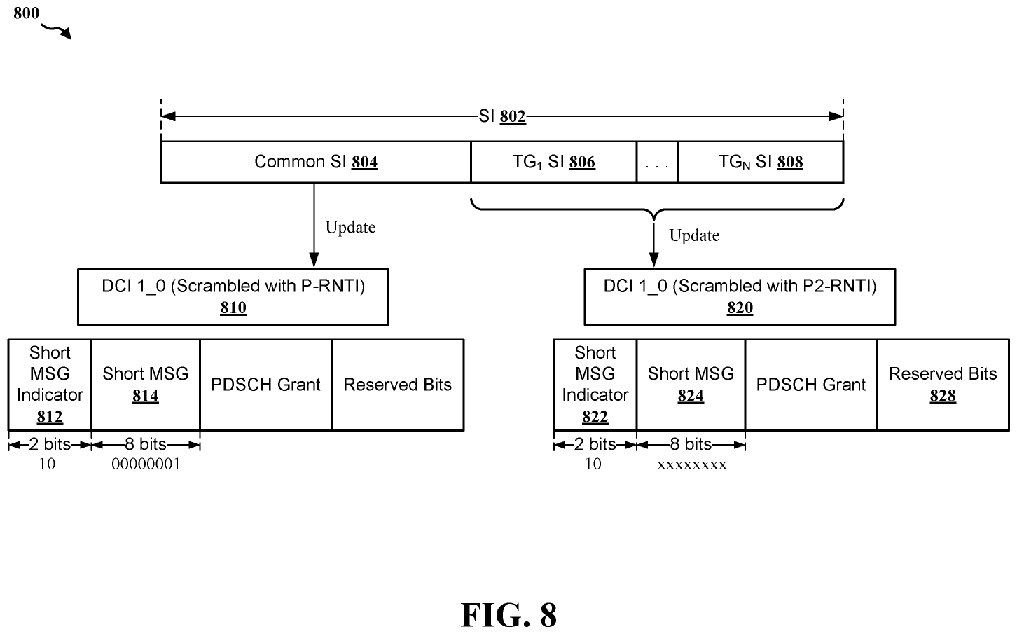

FIG. 8 is a diagram 800 of a targeted SI update indication and associated DCI of a method of wireless communication. An SI 802 of a network node may include SI parameters or IEs of a set of wireless devices communicating with the network node. The SI 802 may include a common SI 804 and a set of target group (TG) SIs including a first TG SI 806 to N^{th} TG SI 808. The first TG SI 806 may be associated with a first subset of wireless devices, and the N^{th} TG SI 808 may be associated with an N^{th} subset of wireless devices. The network node may detect an update in the SI 802, and determine to send the SI update to at least one wireless device of the set of wireless devices. The network node may obtain the SI update in the common SI 804, and the network node may be configured to transmit a common SI update indication to the set of network devices. The network node may obtain the SI update in the at least one TG SI, and the network node may be configured to transmit a targeted SI update indication targeted to the subset of wireless devices associated with the at least one TG SI with the SI update.

The network node may obtain the SI update in the common SI 804, and the network node may be configured to transmit a common SI update indication to the set of network devices. The common SI update indication may be transmitted in a common DCI 1_0 810 scrambled with the P-RNTI, and the common DCI 1_0 810 may include a short message indicator 812, a short message 814, a PDSCH grant, and reserved bits. For example, the short message indicator 812 may have the bit value of 10 indicating that the short message 814 is present in the DCI but not the scheduling information for Paging, and the short message 814 may have the first bit-field value of 1 indicating that SI update is for the BCCH modification other than SIB6, SIB7, and SIB8.

In some aspects, the network node may obtain the SI update in the at least one TG SI including the first TG SI 806 to the N^{th} TG SI 808, and the network node may transmit the targeted SI update indication targeted to one or more subsets of wireless devices associated with the at least one TG SI with the SI update. The targeted SI update indication may be transmitted in a targeted DCI 1_0 820 scrambled with a new (or dedicated) P-RNTI (P2-RNTI), and the P2-RNTI may indicate that the targeted DCI 1_0 820 is targeted to the one or more subsets of wireless devices. Accordingly, the P2-RNTI configured for scrambling the target DCI 1_0 may indicate that the targeted DCI 1_0 820 is targeted to the one or more subsets of wireless devices.

In one aspect, the bit value of the short message indicator 822 may be configured to indicate that the targeted DCI 1_0 820 is targeted to the one or more subsets of wireless devices, and the short message 824 as a whole may be configured to identify the one or more subsets of wireless devices associated with the targeted SI update indicated by the targeted DCI 1_0 820. The short message indicator 812 may have the bit value of 10 indicating that the short message 814 is present in the DCI but not the scheduling information for paging, and the first bit-field of the short message 814 may have the bit value of 1 indicating that SI update is for the BCCH modification other than SIB6, SIB7, and SIB8. The eight bit-fields (e.g., the bit fields 1, 2, 3, 4, 5, 6, 7, and 8) of the short message 824 may represent the bitmap, each bit of the bitmap being respectively mapped to up to eight (8) subsets of wireless devices, and support up to eight (8) subsets of wireless devices.

In one example, the at least one TG SI may include eight (8) TG SIs, including the first TG SI 806 to the eighth TG SI 808, respectively associated with a first subset of wireless devices to an eighth subset of wireless devices. The bit field 1 of the short message 824 may be mapped to the first subset of wireless devices associated with the first TG SI 806, and the bit field 8 of the short message 824 may be mapped to the eighth subset of wireless devices associated with the eighth TG SI 808. For example, the short message 824 may have the bit value of 10000001, indicating that the network node may transmit the SI update of the first TG SI 806 and the eighth TG SI 808 respectively associated with the first subset of wireless devices and the eighth subset of wireless devices.

Furthermore, the reserved bits 828 may also be configured to support more than eight (8) subsets of wireless devices. For example, two (2) bit-fields of the reserved bits 828 may be configured for the target SI update indication, and the targeted DCI 1_0 802 may support up to ten (10) subsets of wireless devices using the eight (8) reserved bit-fields of the short message 824 and the two (2) bit-fields of the reserved bits 828.

In some aspects, the targeted SI update indication may be transmitted in a second targeted DCI 1_0 scrambled with another new (or a second dedicated) P-RNTI (P3-RNTI), and the P3-RNTI may indicate that the second targeted DCI 1_0 is targeted to one or more subsets of wireless devices of another set of subsets of wireless devices. Accordingly, the P3-RNTI configured for scrambling the second target DCI 1_0 may indicate that the second targeted DCI 1_0 is targeted to the one or more subsets of wireless devices of another set of subsets of wireless devices.

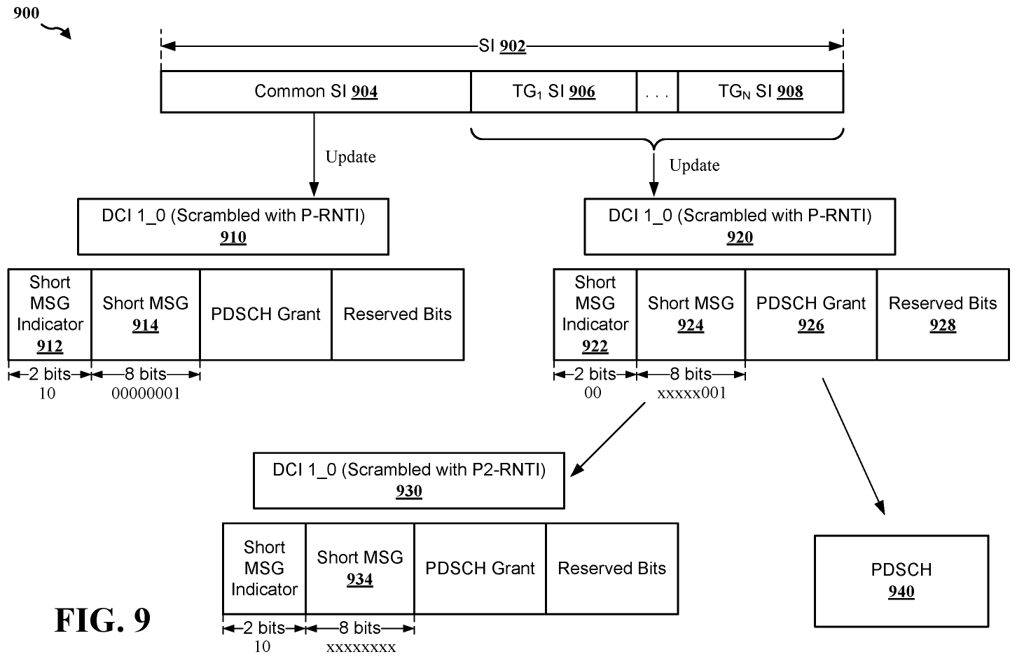

FIG. 9 is a diagram 900 of a targeted SI update indication and associated DCI of a method of wireless communication. An SI 902 of a network node may include SI parameters or IEs of a set of wireless devices communicating with the network node. The SI 902 may include a common SI 904 and a set of target group (TG) SIs including a first TG SI 906 to N^{th} TG SI 908. The first TG SI 906 may be associated with a first subset of wireless devices, and the N^{th} TG SI 908 may be associated with an N^{th} subset of wireless devices. The network node may detect an update in the SI 902, and determine to send the SI update to at least one wireless device of the set of wireless devices. The network node may obtain the SI update in the common SI 904, and the network node may be configured to transmit a common SI update indication to the set of network devices. The network node may obtain the SI update in the at least one TG SI, and the network node may be configured to transmit a targeted SI update indication targeted to the subset of wireless devices associated with the at least one TG SI with the SI update.

The network node may obtain the SI update in the common SI 904, and the network node may be configured to transmit a common SI update indication to the set of network devices. The common SI update indication may be transmitted in a common DCI 1_0 910 scrambled with the P-RNTI, and the common DCI 1_0 910 may include a short message indicator 912, a short message 914, a PDSCH grant, and reserved bits. For example, the short message indicator 912 may have the bit value of 10 indicating that the short message 914 is present in the DCI but not the scheduling information for Paging, and the short message 914 may have the first bit-field value of 1 indicating that SI update is for the BCCH modification other than SIB6, SIB7, and SIB8.

In some aspects, at least one bit of the reserved bit field of the targeted DCI 1_0 920 may be configured to indicate that the targeted DCI 1_0 920 is targeted to the one or more subsets of wireless devices. In one example, the reserved bit value (e.g., the bit value of 00) of the short message indicator 922 may be configured to indicate that the targeted DCI 1_0 920 is targeted to the one or more subsets of wireless devices. In another example, at least one bit of the reserved bit field of the short message 924 of the targeted DCI 1_0 920 may be configured to indicate that the targeted DCI 1_0 920 is targeted to the one or more subsets of wireless devices. In another example, at least one bit of the reserved bit field of the reserved bits 928 of the targeted DCI 1_0 920 may be configured to indicate that the targeted DCI 1_0 920 is targeted to the one or more subsets of wireless devices. Based on the indication of the at least one bit of the reserved bit field of the targeted DCI 1_0 920 that the targeted DCI 1_0 920 is targeted to the one or more subsets of wireless devices, the network node may transmit another signal identifying the one or more subsets of wireless devices associated with the targeted SI update.

In one aspect, based on the indication of the at least one bit of the reserved bit field of the targeted DCI 1_0 920 that the targeted DCI 1_0 920 is targeted to the one or more subsets of wireless devices, the network node may transmit a second targeted DCI 1_0 930 scrambled with the P2-RNTI. That is, based on the indication of the at least one bit of the reserved bit field of the targeted DCI 1_0 920 that the targeted DCI 1_0 920 is targeted to the one or more subsets of wireless devices, the set of network devices that may support the targeted SI update may monitor for the second targeted DCI 1_0 930 scrambled with the P2-RNTI. The short message 934 as a whole may be configured to identify the one or more subsets of wireless devices associated with the targeted SI update indicated by the second targeted DCI 1_0 930. The at least one TG SI may include eight (8) TG SIs, including the first TG SI 906 to the eighth TG SI 908, respectively associated with a first subset of wireless devices to an eighth subset of wireless devices. The bit field 1 of the short message 924 may be mapped to the first subset of wireless devices associated with the first TG SI 906, and the bit field 8 of the short message 924 may be mapped to the eighth subset of wireless devices associated with the eighth TG SI 908. For example, the short message 924 may have the bit value of 10000001, indicating that the network node may transmit the SI update of the first TG SI 906 and the eighth TG SI 908 respectively associated with the first subset of wireless devices and the eighth subset of wireless devices.

Furthermore, the reserved bits 928 may also be configured to support more than eight (8) subsets of wireless devices. For example, two (2) bit-fields of the reserved bits 928 may be configured for the target SI update indication, and the targeted DCI 1_0 920 may support up to ten (10) subsets of wireless devices using the eight (8) reserved bit-fields of the short message 924 and the two (2) bit-fields of the reserved bits 928.

In another aspect, based on the indication of the at least one bit of the reserved bit field of the targeted DCI 1_0 920 that the targeted DCI 1_0 920 is targeted to the one or more subsets of wireless devices, the network node may transmit a bitmap in the PDSCH 940 scheduled by the PDSCH grant 926 transmitting the DCI 1_0 920. That is, based on the indication of the at least one bit of the reserved bit field of the targeted DCI 1_0 920 that the targeted DCI 1_0 920 is targeted to the one or more subsets of wireless devices, the set of network devices that may receive the PDSCH 940 based on the PDSCH grant 926, and the PDSCH grant 926 may include the targeted SI update as well as the bitmap identifying the one or more subsets of wireless devices associated with the targeted SI update.

In some aspects, the network node and the set of network devices may communicate to configure the targeted SI update indication. In one aspect, the network node may configure a number of target group SI blocks and which SI IEs are associated with respective target group SI blocks. The network node may transmit a signal to configure the number of target group SI blocks corresponding to the subsets of wireless devices. For example, the network node may transmit the configuration of multiple (e.g., a number of N) target group SI blocks. The network node may also configure the SI IEs associated with the respective target group SI blocks corresponding to the subsets of wireless devices.

In one aspect, the configuration of the target group SI blocks and the associated SI IEs may be explicitly indicated to the set of network devices. The network node may transmit a bitmap or a list of IE indices or names to the set of network devices to indicate the IEs associated with each target group SI blocks. In another aspect, the configuration of the target group SI blocks and the associated SI IEs may be implicitly indicated through an association of each target group SI block to a specific feature (e.g., IAB, reduced capacity (RedCap), coverage enhancement (CovEnh), non-terrestrial network (NTN), NES, power saving (PS), unmanned aerial vehicle (UAV), etc.). Here, some IEs may be associated with more than one TG IE blocks, and if the IE associated with more than one TG IE blocks.

In some aspects, the network node and the set of network devices may communicate to each other whether the network node and/or the set of network devices may support the feature of targeted SI update indication. In one aspect, the wireless device may indicate the network node whether the wireless device may support the feature of targeted SI update indication. The network node may perform the targeted SI update indication feature based on the indication whether the wireless device supports the targeted SI update indication.

In another aspect, the network node (or a cell) may indicate whether the network node may support the feature of targeted SI update indication. In one example, the network node may transmit the notice that the network node may support the feature of targeted SI update indication in the SIB1. In another example, the network node may dynamically transmit the notice that the network node may support the feature of targeted SI update indication via a wake up signal (WUS), permanent equipment identifier (PEI), or flags in the paging PDCCH. In another example, the network device (e.g., UE) may be indicated by an operation/administration/management (OAM) function of the network whether the targeted SI update indication feature is supported in the network (e.g., for a given public mobile network (PLMN)).

The configuration of the targeted SI update indication may further include a mapping of the TG IE blocks to the corresponding bit-fields of the DCI 1_0 identifying the subset of network devices. For example, the configuration of the targeted SI update indication may include at least one of a mapping between the at least one TG SI including the first TG SI 706 to the N^{th} TG SI 708 and the reserved bit-fields of the short message 724 or the bit-fields of the short message 734, a mapping between the at least one TG SI including the first TG SI 806 to the N^{th} TG SI 808 and the bit-fields of the short message 824, or a mapping between the at least one TG SI including the first TG SI 906 to the N^{th} TG SI 908 and the bit-fields of the short message 924.

The target group SI blocks and the associated SI IEs may be configured via various implementations. In one example, the configuration/indication/association of the target group SI blocks and associated IEs may be specified for the network node and the set of network devices. In another example, the configuration/indication/association of the target group SI blocks and associated IEs may be broadcast or provided to the set of network devices in a dedicated signal (e.g., RRC message). In another example, the configuration/indication/association of the target group SI blocks and associated IEs may be combination of being specified for the network node and the set of network devices and broadcasted by the network node to the set of network devices in the dedicated signal.

In some aspects, the network devices that may support the P2-RNTI (or support multiple P2-RNTIs) may adopt to follow one of following two behaviors. First, the network device may be configured to monitor for the DCI 1_0 scrambled with both P-RNTI and P2-RNTI. Second, the network device may be configured to monitor for the DCI 1_0 scrambled with P2-RNTI. Based on the network device following the first behavior of monitoring for the DCI 1_0 scrambled with both P-RNTI and P2-RNTI, the network node may use the DCI 1_0 scrambled with the P-RNTI to transmit the common SI update indication for the network device as well as all network devices of the set of network devices. Based on the network device following the second behavior of monitoring for the DCI 1_0 scrambled with P2-RNTI, the network node may need to transmit a separate DCI 1_0 scrambled with the P2-RNTI to transmit the common SI update indication to the network device following the second behavior.

The configuration of the network device's behavior may have an impact on the power consumption of the network device and the network. In one aspect, for the network node and the network device of a set of network devices following the first behavior of monitoring for the DCI 1_0 scrambled with both P-RNTI and P2-RNTI, and the network node may transmit the common SI update using the P-RNTI and transmit the targeted SI update to the subset of wireless devices using the P2-RNTI. The network may have reduced power consumption by transmitting the targeted SI updates using the P2-RNTI to the network node. The network device configured to monitor for both of the common DCI 1_0 and the targeted DCI 1_0 may have some increased power consumption; however, the network device may disregard the targeted DCI 1_0 that are not associated with the network node, and accordingly, may reduce the overall power consumption at the network device side.

In another aspect, the network device may be configured to monitor for the DCI 1_0 scrambled with P2-RNTI, but not the DCI 1_0 scrambled with the P-RNTI. To accommodate for the network device following the second behavior, the network node may transmit the common SI update using the P-RNTI to transmit the common SI update for the network device following the second behavior and transmit the targeted SI update to the subset of wireless devices using the P2-RNTI. The network may have an increased power consumption because the network node may transmit two different DCIs including the common DCI 1_0 scrambled with the P-RNTI transmitted to the set of network nodes not following the second behaviors, and the common DCI 1_0 scrambled with the P2-RNTI transmitted to the network node following the second behavior.

In a similar manner, when the network node is configured to transmit the targeted SI update indication to the subset of directions with respect to the network node to target the subset of wireless devices located in the subset of directions with respect to the network node, cells associated with the network node may reduce some power consumption because the targeted SI update indication is transmitted to the relevant region.

In some aspects, the network node and the set of network devices that may support the P2-RNTI may communicate to each other to configure the behavior of the network device. That is, in case the network node may support the both behaviors of network devices that may support using the P2-RNTI for indicating the targeted SI update in the DCI 1_0 scrambled with the P2-RNTI, the network node and the network node may indicate that the network node or the network device may support both of the behaviors of the network device supporting the use of P2-RNTI for indicating the targeted SI update in the DCI 1_0 scrambled with the P2-RNTI.

In one aspect, each network device (e.g., UE) may transmit a notice to the network node whether the network device may support either one of the behaviors or both of the behaviors associated with the P2-RNTI. The network device may further indicate whether the network device may support multiple P2-RNTIs or a number of multiple P2-RNTIs that the network device may support.

In another aspect, the network node (or a cell) may transmit (or broadcast) a notice to the set or network devices whether the network node may support either one of the behaviors or both of the behaviors associated with the P2-RNTI. The network node may further indicate whether the network node may support multiple P2-RNTIs or a number of multiple P2-RNTIs that the network node may support.

In some aspects, the network node may configure or activate the behavior that the network devices supporting the P2-RNTI should follow. In one example, the network node may transmit the configuration of behaviors for the network device supporting P2-RNTI in the SIB1. In another example, the network node may dynamically transmit the configuration of behaviors for the network device supporting P2-RNTI via the WUS, the PEI, or flags in the paging PDCCH. The behavior may be differently activated or configured for different target groups, different time intervals, different cells, different features, different beam directions.

In some aspects, the targeted SI update indication may also dynamically indicate the updated parameters of the targeted SI update to the network devices. In one aspect, the targeted SI update indication may be carried in the payload of the PDSCH scheduled by the targeted SI update indication. In another aspect, the targeted SI update indication may be carried in the payload of the PDSCH scheduled by a dedicated group-common PDCCH. That is, the dedicated group-common PDCCH may be configured specific to the subset of network devices, and the PDSCH scheduled by the dedicated group-common PDCCH may carry the targeted SI update indication and the corresponding information of the targeted SI update. For example, the payload of the PDSCH schedule by the targeted SI update indication may include at least one or a combination of the following indications of the SI update; (1) an indication of the SI update indication, (2) an indication of which SIB has been updated, (3) an indication of which IE has been updated, or (4) the updated parameters directly provided in the PDSCH payload

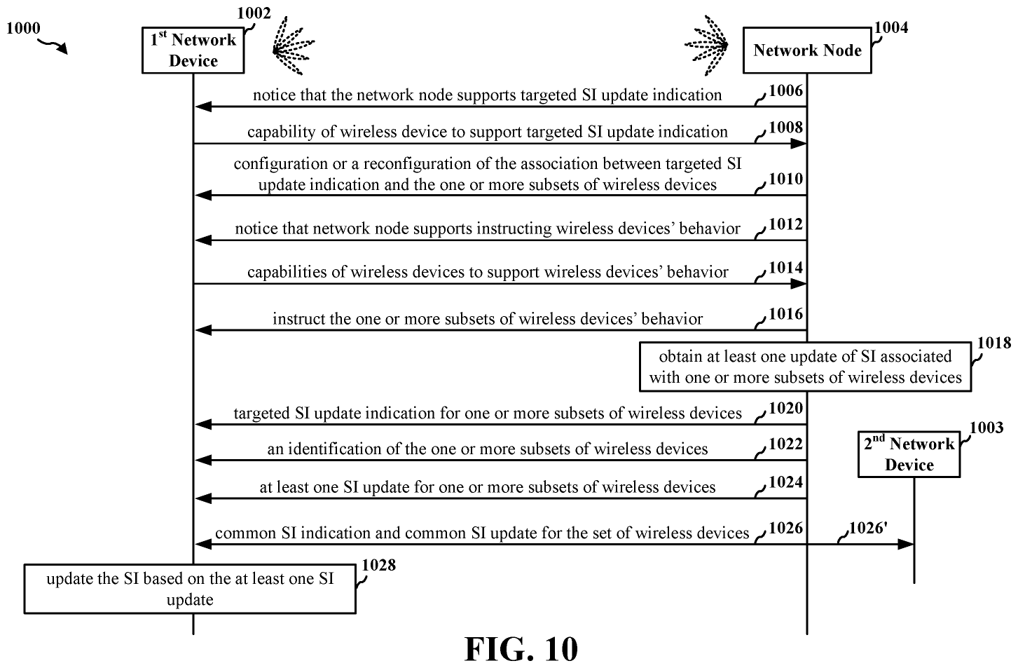

FIG. 10 is a call-flow diagram 1000 of a method of wireless communication. The call-flow diagram 1000 may include a network device 1002 and a network node 1004. The network node 1004 may transmit a target SI update indication for the one or more subsets of wireless devices among the set of wireless devices associated with the network node 1004 or for the subset of directions, and the first network device 1002 of the one or more subsets of wireless devices may receive the target SI update indication and the associated targeted SI update from the network node 1004. The network node 1004 and the set of network devices including the first network device 1002 may reduce the overall power consumption by transmitting the targeted SI update indication and the targeted SI update to one or more subsets of network devices relevant to the targeted SI update. Here, the subset of wireless devices may include at least one of a user equipment or a child IAB node.

The network node 1004 and the first network device 1002 may communicate to each other whether the network node 1004 and/or the first network device 1002 may support the feature of targeted SI update indication.

At 1006, the network node 1004 may transmit a notice that the network node 1004 may support the targeted SI update indication for the one or more subsets of wireless devices, where the targeted SI update indication may be transmitted for the one or more subsets of wireless devices at 1020 based on the notice that the network node 1004 supports the targeted SI update indication for the one or more subsets of wireless devices. The first network device 1002 may receive a notice that the network node 1004 supports the targeted SI update indication for the one or more subsets of wireless devices from the network node 1004, where the targeted SI update indication may be received from the network node 1004 at 1020 based on the notice that the network node 1004 supports the targeted SI update indication for the one or more subsets of wireless devices.

At 1008, the first network device 1002 may transmit capabilities of the one or more subsets of wireless devices to support the targeted SI update indication including a downlink grant of the at least one SI update associated with the one or more subsets of wireless devices, where the targeted SI update indication may be received from the network node 1004 based on the capabilities of the wireless device transmitted to the network node 1004 at 1020. The network node 1004 may obtain capabilities of the one or more subsets of wireless devices to support the targeted SI update indication including a downlink grant of the at least one SI update associated with the one or more subsets of wireless devices, where the targeted SI update indication may be transmitted for the one or more subsets of wireless devices at 1020 based on the obtained capabilities of the one or more subsets of wireless devices.

At 1010, the network node 1004 may transmit a configuration or a reconfiguration of the association between the targeted SI update indication and the one or more subsets of wireless devices, where the targeted SI update indication may be transmitted for the one or more subsets of wireless devices at 1020 based on the configuration or the reconfiguration of the association between the targeted SI update indication and the one or more subsets of wireless devices. The first network device 1002 may receive a configuration or a reconfiguration of the association between the targeted SI update indication and the one or more subsets of wireless devices including the wireless device, where the targeted SI update indication may be received from the network node 1004 at 1020 based on the configuration or the reconfiguration of the association between the targeted SI update indication and the one or more subsets of wireless devices including the wireless device.

The configuration of the targeted SI update indication may further include a mapping of the target group IE blocks to the corresponding bit-fields of the DCI 1_0 identifying the subset of network devices. Based on the configuration, the network node 1004 may indicate that the targeted SI update indication is for one or more subsets of wireless devices including the first network device 1002, and identify the one or more subsets of wireless devices. The configuration or the reconfiguration of the association between the targeted SI update indication and the one or more subsets of wireless devices may be based on at least one of a direction of the one or more subsets of network devices with respect to the network node, a context of supported features, etc. In one aspect, the configuration or the reconfiguration of the targeted SI update indication, the target group SI blocks, and the corresponding subset of network devices may be explicitly indicated to the set of network devices. The network node may transmit a bitmap or a list of IE indices or names to the set of network devices to indicate the SI IEs associated with each target group SI block. In another aspect, the configuration of the targeted SI update indication, the target group SI blocks, and the corresponding subset of network devices may be implicitly indicated through an association of each target group SI block to a specific feature (e.g., IAB, RedCap, CovEnh, NTN, NES, PS, UAV, etc.).

At 1012, the network node 1004 may transmit a notice that the network node 1004 supports instructing the one or more subsets of wireless devices' behavior. The first network device 1002 may receive a notice that the network node 1004 supports the targeted SI update indication for the one or more subsets of wireless devices from the network node 1004, where the targeted SI update indication may be received from the network node 1004 based on the notice that the network node 1004 supports the targeted SI update indication for the one or more subsets of wireless devices at 1016.

At 1014, the first network device 1002 may transmit a capability of the wireless device to support the wireless device's behavior, where the wireless device's behavior is instructed based on the capability of the wireless devices. The network node 1004 may obtain capabilities of the one or more subsets of wireless devices to support the one or more subsets of wireless devices' behavior, where the one or more subsets of wireless devices' behavior is instructed at 1016 based on the obtained capabilities of the one or more subsets of wireless devices.

At 1016, the network node 1004 may instruct the one or more subsets of wireless devices' behavior to either (A) monitor for DCI 1_0 scrambled with a common P-RNTI and DCI 1_0 scrambled with a P2-RNTI, the common P-RNTI associated with the set of wireless devices, or (B) monitor for DCI 1_0 scrambled with the P2-RNTI. The first network device 1002 may receive an instruction of a wireless device's behavior to either (A) monitor for DCI 1_0 scrambled with a common P-RNTI and DCI 1_0 scrambled with a P2-RNTI, the common P-RNTI associated with a set of wireless devices, or (B) monitor for DCI 1_0 scrambled with a P2-RNTI. The first network device 1002 that may support the P2-RNTI (or support multiple P2-RNTIs) may adopt to follow one of following two behaviors. First, the first network device 1002 may be configured to monitor for the DCI 1_0 scrambled with both P-RNTI and P2-RNTI. Second, the first network device 1002 may be configured to monitor for the DCI 1_0 scrambled with P2-RNTI. The network node 1004 may instruct the first network device 1002 to select one of the first behavior or the second behavior. Based on the behavior that the first network device 1002 may follow, the network node 1004 may transmit the common SI update in the corresponding manner.

At 1018, the network node 1004 may obtain at least one update of a SI associated with one or more subsets of wireless devices among a set of wireless devices associated with the network node 1004 or a subset of directions from the network node 1004. The network node 1004 may obtain the at least one SI update that is associated with one or more subsets of wireless devices, and the one or more subsets of wireless devices may be associated with a target group SIs (or TG IE blocks).

At 1020, the network node 1004 may transmit a targeted SI update indication for the one or more subsets of wireless devices among the set of wireless devices associated with the network node 1004 or for the subset of directions, the targeted SI update indication including a downlink grant of the at least one SI update associated with the one or more subsets of wireless devices or the subset of directions as obtained at 1018. The first network device 1002 may receive a targeted SI update indication for one or more subsets of wireless devices including the wireless device from a network node 1004, the targeted SI update indication including a downlink grant of at least one SI update associated with the one or more subsets of wireless devices of a set of wireless devices.

In one aspect, the targeted SI update indication may be for the subset of directions and is output for transmission in the subset of directions. That is, some parameters of SI may be beam-specific (e.g., transmit-receive point (TRP)-specific), and update to the beam-specific SI may be relevant to a direction with respect to the network node and the SI configuration and update may be relevant to the direction of the one or more subsets of network devices with respect to the network node. Here, the targeted SI update may be relevant to the first network device 1002 but not relevant to the second network device 1003.

In some aspects, the targeted SI update indication may include an indicator that the targeted SI update indication is associated with the one or more subsets of wireless devices. In one aspect, the targeted SI update indication may be transmitted in DCI 1_0 scrambled with a common P-RNTI. At least one of a short message indicator of the DCI 1_0 or at least one bit of a short message of the DCI 1_0 may be the indicator that the targeted SI update indication is associated with the one or more subsets of wireless devices. In one example, reserved bits of the short message of the DCI 1_0 may include a bitmap indicating the one or more subsets of wireless devices associated with the targeted SI update indication, and a presence of the bitmap in the reserved bits of the short message of the DCI 1_0 may be the indicator that the targeted SI update indication is associated with the one or more subsets of wireless devices. In another example, the short message indicator of the DCI 1_0 may be the indicator that the targeted SI update indication is associated with the one or more subsets of wireless devices, where the short message of the DCI 1_0 may include a bitmap indicating the one or more subsets of wireless devices associated with the targeted SI update indication.

In another aspect, the P-RNTI may be a P2-RNTI associated with the one or more subsets of wireless devices, and the P2-RNTI may be the indicator that the targeted SI update indication is associated with the one or more subsets of wireless devices. A short message of the DCI 1_0 scrambled with the P2-RNTI may include a bitmap indicating the one or more subsets of wireless devices associated with the targeted SI update indication. In another aspect, at least one reserved bit of the DCI 1_0 may be the indicator that the targeted SI update indication is associated with the one or more subsets of wireless devices. The network node 1004 may transmit an identification of the one or more subsets of wireless devices associated with the targeted SI update indication at 1022. In another aspect, the targeted SI update indication for the one or more subsets of wireless devices may be transmitted in a PDSCH or a dedicated group-common PDCCH

At 1022, based on at least one reserved bit of the DCI 1_0 being the indicator that the targeted SI update indication is associated with the one or more subsets of wireless devices, the network node 1004 may transmit an identification of the one or more subsets of wireless devices associated with the targeted SI update indication. Based on at least one reserved bit of the DCI 1_0 being the indicator that the targeted SI update indication is associated with the one or more subsets of wireless devices, the first network device 1002 may receive an identification of the one or more subsets of wireless devices associated with the targeted SI update indication. In one aspect, the identification of the one or more subsets of wireless devices associated with the targeted SI update indication may be transmitted in a second DCI 1_0 scrambled with a P2-RNTI associated with the one or more subsets of wireless devices, a short message of the second DCI 1_0 including the bitmap indicating the one or more subsets of wireless devices associated with the targeted SI update indication. In another aspect, the identification of the one or more subsets of wireless devices associated with the targeted SI update indication may be transmitted in a downlink payload associated with the downlink grant of the SI in the targeted SI update indication, the downlink payload including the bitmap indicating the one or more subsets of wireless devices associated with the targeted SI update indication.

At 1024, the network node 1004 may transmit at least one SI update for the one or more subsets of wireless devices based on the downlink grant of the at least one SI update associated with the one or more subsets of wireless devices in the targeted SI update indication at 1020. The first network device 1002 may receive the at least one SI update from the network node 1004 based on the downlink grant of the at least one SI update associated with the one or more subsets of wireless devices including the wireless device received in the targeted SI update indication at 1020.

At 1026 and 1026′, the network node 1004 may transmit a common SI indication for the set of wireless devices associated with the network node 1004. In one aspect, the common SI indication for the set of wireless devices associated with the network node 1004 may be transmitted in a common DCI 1_0 scrambled with the common P-RNTI based on instructing the one or more subsets of wireless devices to monitor for common DCI 1_0 scrambled with a common P-RNTI and DCI 1_0 scrambled with the P2-RNTI, where the common SI indication including a downlink grant of a common SI update associated with the set of wireless devices. That is, the network node 1004 may transmit the common SI indicator for the first network device 1002 and the second network device 1003 in a common DCI 1_0 scrambled with the common P-RNTI based on instructing the one or more subsets of wireless devices to monitor for common DCI 1_0 scrambled with a common P-RNTI and DCI 1_0 scrambled with the P2-RNTI, where the common SI indication including a downlink grant of a common SI update associated with the set of wireless devices (1026 and 1026′). In another aspect, the common SI indication for the set of wireless devices associated with the network node 1004 may be transmitted in (A) a first common DCI 1_0 scrambled with the P2-RNTI for the one or more subsets of wireless devices, and (B) a second common DCI 1_0 scrambled with a common P-RNTI for wireless devices of the set of wireless devices other than the one or more subsets of wireless devices, based on instructing the one or more subsets of wireless devices to monitor for the DCI 1_0 scrambled with the P2-RNTI. That is, the network node 1004 may transmit the common SI indicator to the first network device 1002 in a first common DCI 1_0 scrambled with the P2-RNTI for the one or more subsets of wireless devices (at 1026), and to the second network device 1003 in a second common DCI 1_0 scrambled with a common P-RNTI for wireless devices of the set of wireless devices other than the one or more subsets of wireless devices (at 1026′).

At 1026, the first network device 1002 may receive a common SI indication for the set of wireless devices associated with the network node 1004 in a common DCI 1_0 scrambled with the common P-RNTI based on the instruction of the wireless device to monitor for common DCI 1_0 scrambled with a common P-RNTI and DCI 1_0 scrambled with the P2-RNTI, the common SI indication including a downlink grant of a common SI update associated with the set of wireless devices.

At 1028, the first network device 1002 may update the SI based on the at least one SI update received from the network node 1004. In one example, the at least one SI update may include the at least one SI update received at 1024 based on the targeted SI update indication for one or more subsets of wireless devices including the wireless device as received at 1020. In another example, the at least one SI update may include a common SI update received based on the common SI indication as received at 1026.

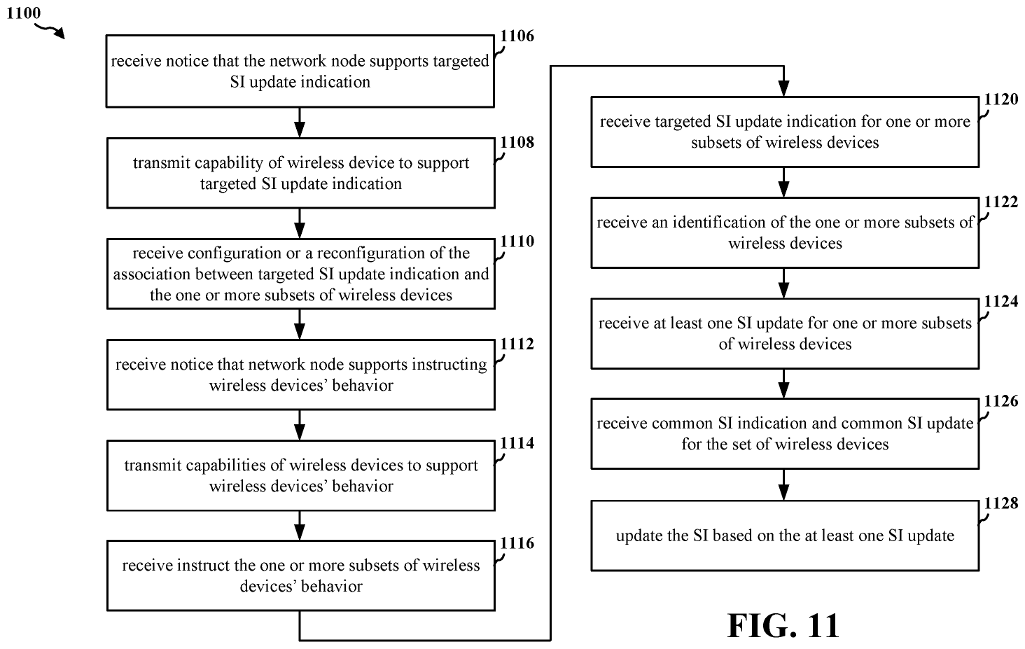

FIG. 11 is a flowchart 1100 of a method of wireless communication. The method may be performed by a network device (e.g., the UE 104; the IAB nodes 103; the network device 1002; the apparatus 1504). The network device may be connected to a network node, and the network node may transmit a target SI update indication for the one or more subsets of wireless devices among the set of wireless devices associated with the network node or for the subset of directions. The network device of the one or more subsets of wireless devices may receive the target SI update indication and the associated targeted SI update from the network node. The network node and the network device may reduce the overall power consumption by transmitting the targeted SI update indication and the targeted SI update to one or more subsets of network devices relevant to the targeted SI update. Here, the wireless device may include at least one of a user equipment or a child IAB node.

The network node and the network device may communicate to each other whether the network node and/or the network device may support the feature of targeted SI update indication.

At 1106, the network device may receive a notice that the network node supports the targeted SI update indication for the one or more subsets of wireless devices from the network node, where the targeted SI update indication may be received from the network node at 1120 based on the notice that the network node supports the targeted SI update indication for the one or more subsets of wireless devices. For example, at 1006, the first network device 1002 may receive a notice that the network node 1004 supports the targeted SI update indication for the one or more subsets of wireless devices from the network node 1004, where the targeted SI update indication may be received from the network node 1004 at 1020 based on the notice that the network node 1004 supports the targeted SI update indication for the one or more subsets of wireless devices. Furthermore, 1106 may be performed by a targeted SI indication receiving component 198.

At 1108, the network device may transmit capabilities of the one or more subsets of wireless devices to support the targeted SI update indication including a downlink grant of the at least one SI update associated with the one or more subsets of wireless devices, where the targeted SI update indication may be received from the network node based on the capabilities of the wireless device transmitted to the network node at 1120. For example, at 1008, the first network device 1002 may transmit capabilities of the one or more subsets of wireless devices to support the targeted SI update indication including a downlink grant of the at least one SI update associated with the one or more subsets of wireless devices, where the targeted SI update indication may be received from the network node 1004 based on the capabilities of the wireless device transmitted to the network node 1004 at 1020. Furthermore, 1108 may be performed by the targeted SI indication receiving component 198.

At 1110, the network device may receive a configuration or a reconfiguration of the association between the targeted SI update indication and the one or more subsets of wireless devices including the wireless device, where the targeted SI update indication may be received from the network node at 1120 based on the configuration or the reconfiguration of the association between the targeted SI update indication and the one or more subsets of wireless devices including the wireless device. The configuration of the targeted SI update indication may further include a mapping of the target group IE blocks to the corresponding bit-fields of the DCI 1_0 identifying the subset of network devices. Based on the configuration, the network node may indicate that the targeted SI update indication is for one or more subsets of wireless devices including the network device, and identify the one or more subsets of wireless devices. The configuration or the reconfiguration of the association between the targeted SI update indication and the one or more subsets of wireless devices may be based on at least one of a direction of the one or more subsets of network devices with respect to the network node, a context of supported features, etc. In one aspect, the configuration or the reconfiguration of the targeted SI update indication, the target group SI blocks, and the corresponding subset of network devices may be explicitly indicated to the set of network devices. The network node may transmit a bitmap or a list of IE indices or names to the set of network devices to indicate the SI IEs associated with each target group SI block. In another aspect, the configuration of the targeted SI update indication, the target group SI blocks, and the corresponding subset of network devices may be implicitly indicated through an association of each target group SI block to a specific feature (e.g., IAB, RedCap, CovEnh, NTN, NES, PS, UAV, etc.). For example, at 1010, the first network device 1002 may receive a configuration or a reconfiguration of the association between the targeted SI update indication and the one or more subsets of wireless devices including the wireless device, where the targeted SI update indication may be received from the network node 1004 at 1020 based on the configuration or the reconfiguration of the association between the targeted SI update indication and the one or more subsets of wireless devices including the wireless device. Furthermore, 1110 may be performed by the targeted SI indication receiving component 198.

At 1112, the network device may receive a notice that the network node supports the targeted SI update indication for the one or more subsets of wireless devices from the network node, where the targeted SI update indication may be received from the network node based on the notice that the network node supports the targeted SI update indication for the one or more subsets of wireless devices at 1116. For example, at 1012, the first network device 1002 may receive a notice that the network node 1004 supports the targeted SI update indication for the one or more subsets of wireless devices from the network node 1004, where the targeted SI update indication may be received from the network node 1004 based on the notice that the network node 1004 supports the targeted SI update indication for the one or more subsets of wireless devices at 1016. Furthermore, 1112 may be performed by the targeted SI indication receiving component 198.

At 1114, the network device may transmit a capability of the wireless device to support the wireless device's behavior, where the wireless device's behavior is instructed based on the capability of the wireless devices. For example, at 1014, the first network device 1002 may transmit a capability of the wireless device to support the wireless device's behavior, where the wireless device's behavior is instructed based on the capability of the wireless devices. Furthermore, 1114 may be performed by the targeted SI indication receiving component 198.

At 1116, the network device may receive an instruction of a wireless device's behavior to either (A) monitor for DCI 1_0 scrambled with a common P-RNTI and DCI 1_0 scrambled with a P2-RNTI, the common P-RNTI associated with a set of wireless devices, or (B) monitor for DCI 1_0 scrambled with a P2-RNTI. The network device that may support the P2-RNTI (or support multiple P2-RNTIs) may adopt to follow one of following two behaviors. First, the network device may be configured to monitor for the DCI 1_0 scrambled with both P-RNTI and P2-RNTI. Second, the network device may be configured to monitor for the DCI 1_0 scrambled with P2-RNTI. The network node may instruct the network device to select one of the first behavior or the second behavior. Based on the behavior that the network device may follow, the network node may transmit the common SI update in the corresponding manner. For example, at 1016, the first network device 1002 may receive an instruction of a wireless device's behavior to either (A) monitor for DCI 1_0 scrambled with a common P-RNTI and DCI 1_0 scrambled with a P2-RNTI, the common P-RNTI associated with a set of wireless devices, or (B) monitor for DCI 1_0 scrambled with a P2-RNTI. The first network device 1002 that may support the P2-RNTI (or support multiple P2-RNTIs) may adopt to follow one of following two behaviors. Furthermore, 1116 may be performed by a targeted SI indication receiving component 198.

At 1120, the network device may receive a targeted SI update indication for one or more subsets of wireless devices including the wireless device from a network node, the targeted SI update indication including a downlink grant of at least one SI update associated with the one or more subsets of wireless devices of a set of wireless devices. For example, at 1020, the first network device 1002 may receive a targeted SI update indication for one or more subsets of wireless devices including the wireless device from a network node 1004, the targeted SI update indication including a downlink grant of at least one SI update associated with the one or more subsets of wireless devices of a set of wireless devices. Furthermore, 1120 may be performed by the targeted SI indication receiving component 198.

In one aspect, the targeted SI update indication may be for the subset of directions and is output for transmission in the subset of directions. That is, some parameters of SI may be beam-specific (e.g., transmit-receive point (TRP)-specific), and update to the beam-specific SI may be relevant to a direction with respect to the network node and the SI configuration and update may be relevant to the direction of the one or more subsets of network devices with respect to the network node. Here, the targeted SI update may be relevant to the network device but not relevant to another network device that is not in the one or more subsets of network devices.

In some aspects, the targeted SI update indication may include an indicator that the targeted SI update indication is associated with the one or more subsets of wireless devices. In one aspect, the targeted SI update indication may be transmitted in DCI 1_0 scrambled with a common P-RNTI. At least one of a short message indicator of the DCI 1_0 or at least one bit of a short message of the DCI 1_0 may be the indicator that the targeted SI update indication is associated with the one or more subsets of wireless devices. In one example, reserved bits of the short message of the DCI 1_0 may include a bitmap indicating the one or more subsets of wireless devices associated with the targeted SI update indication, and a presence of the bitmap in the reserved bits of the short message of the DCI 1_0 may be the indicator that the targeted SI update indication is associated with the one or more subsets of wireless devices. In another example, the short message indicator of the DCI 1_0 may be the indicator that the targeted SI update indication is associated with the one or more subsets of wireless devices, where the short message of the DCI 1_0 may include a bitmap indicating the one or more subsets of wireless devices associated with the targeted SI update indication.

In another aspect, the P-RNTI may be a P2-RNTI associated with the one or more subsets of wireless devices, and the P2-RNTI may be the indicator that the targeted SI update indication is associated with the one or more subsets of wireless devices. A short message of the DCI 1_0 scrambled with the P2-RNTI may include a bitmap indicating the one or more subsets of wireless devices associated with the targeted SI update indication. In another aspect, at least one reserved bit of the DCI 1_0 may be the indicator that the targeted SI update indication is associated with the one or more subsets of wireless devices. The network node may transmit an identification of the one or more subsets of wireless devices associated with the targeted SI update indication at 1122. In another aspect, the targeted SI update indication for the one or more subsets of wireless devices may be transmitted in a PDSCH or a dedicated group-common PDCCH.

At 1122, based on at least one reserved bit of the DCI 1_0 being the indicator that the targeted SI update indication is associated with the one or more subsets of wireless devices, the network device may receive an identification of the one or more subsets of wireless devices associated with the targeted SI update indication. In one aspect, the identification of the one or more subsets of wireless devices associated with the targeted SI update indication may be transmitted in a second DCI 1_0 scrambled with a P2-RNTI associated with the one or more subsets of wireless devices, a short message of the second DCI 1_0 including the bitmap indicating the one or more subsets of wireless devices associated with the targeted SI update indication. In another aspect, the identification of the one or more subsets of wireless devices associated with the targeted SI update indication may be transmitted in a downlink payload associated with the downlink grant of the SI in the targeted SI update indication, the downlink payload including the bitmap indicating the one or more subsets of wireless devices associated with the targeted SI update indication. For example, at 1022, based on at least one reserved bit of the DCI 1_0 being the indicator that the targeted SI update indication is associated with the one or more subsets of wireless devices, the first network device 1002 may receive an identification of the one or more subsets of wireless devices associated with the targeted SI update indication. Furthermore, 1122 may be performed by the targeted SI indication receiving component 198.

At 1124, the network device may receive the at least one SI update from the network node based on the downlink grant of the at least one SI update associated with the one or more subsets of wireless devices including the wireless device received in the targeted SI update indication at 1120. For example, at 1024, the first network device 1002 may receive the at least one SI update from the network node 1004 based on the downlink grant of the at least one SI update associated with the one or more subsets of wireless devices including the wireless device received in the targeted SI update indication at 1020. Furthermore, 1124 may be performed by the targeted SI indication receiving component 198.

At 1126, the network device may receive a common SI indication for the set of wireless devices associated with the network node in a common DCI 1_0 scrambled with the common P-RNTI based on the instruction of the wireless device to monitor for common DCI 1_0 scrambled with a common P-RNTI and DCI 1_0 scrambled with the P2-RNTI, the common SI indication including a downlink grant of a common SI update associated with the set of wireless devices. For example, at 1026, the first network device 1002 may receive a common SI indication for the set of wireless devices associated with the network node 1004 in a common DCI 1_0 scrambled with the common P-RNTI based on the instruction of the wireless device to monitor for common DCI 1_0 scrambled with a common P-RNTI and DCI 1_0 scrambled with the P2-RNTI, the common SI indication including a downlink grant of a common SI update associated with the set of wireless devices. Furthermore, 1126 may be performed by a targeted SI indication receiving component 198.

At 1128, the network device may update the SI based on the at least one SI update received from the network node. In one example, the at least one SI update may include the at least one SI update received at 1124 based on the targeted SI update indication for one or more subsets of wireless devices including the wireless device as received at 1120. In another example, the at least one SI update may include a common SI update received based on the common SI indication as received at 1126. For example, at 1028, the first network device 1002 may update the SI based on the at least one SI update received from the network node 1004. Furthermore, 1128 may be performed by the targeted SI indication receiving component 198.

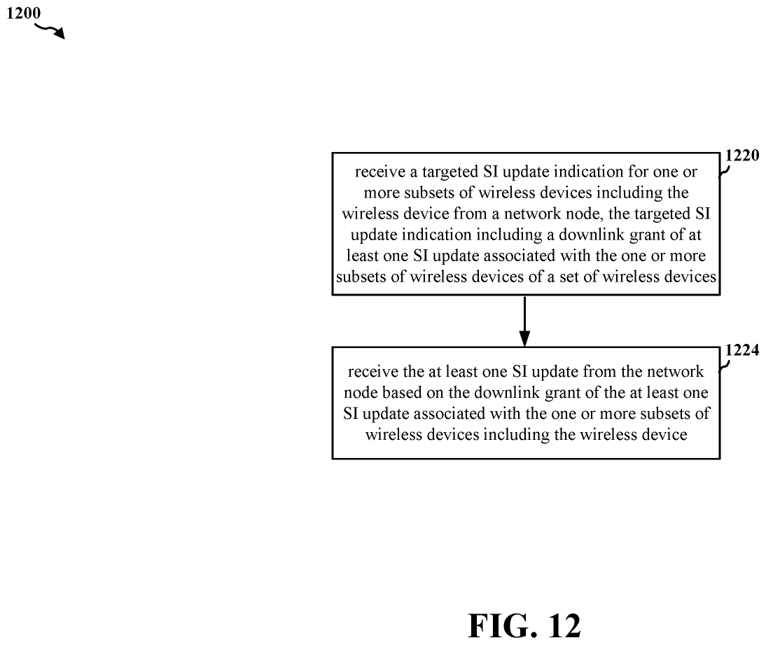

FIG. 12 is a flowchart 1200 of a method of wireless communication. The method may be performed by a network device (e.g., the UE 104; the IAB nodes 103; the network device 1002; the apparatus 1504). The network device may be connected to a network node, and the network node may transmit a target SI update indication for the one or more subsets of wireless devices among the set of wireless devices associated with the network node or for the subset of directions. The network device of the one or more subsets of wireless devices may receive the target SI update indication and the associated targeted SI update from the network node. The network node and the network device may reduce the overall power consumption by transmitting the targeted SI update indication and the targeted SI update to one or more subsets of network devices relevant to the targeted SI update. Here, the wireless device may include at least one of a user equipment or a child IAB node.

The network node and the network device may communicate to each other whether the network node and/or the network device may support the feature of targeted SI update indication.

At 1220, the network device may receive a targeted SI update indication for one or more subsets of wireless devices including the wireless device from a network node, the targeted SI update indication including a downlink grant of at least one SI update associated with the one or more subsets of wireless devices of a set of wireless devices. For example, at 1020, the first network device 1002 may receive a targeted SI update indication for one or more subsets of wireless devices including the wireless device from a network node 1004, the targeted SI update indication including a downlink grant of at least one SI update associated with the one or more subsets of wireless devices of a set of wireless devices. Furthermore, 1220 may be performed by the targeted SI indication receiving component 198.

In one aspect, the targeted SI update indication may be for the subset of directions and is output for transmission in the subset of directions. That is, some parameters of SI may be beam-specific (e.g., transmit-receive point (TRP)-specific), and update to the beam-specific SI may be relevant to a direction with respect to the network node and the SI configuration and update may be relevant to the direction of the one or more subsets of network devices with respect to the network node. Here, the targeted SI update may be relevant to the network device but not relevant to another network device that is not in the one or more subsets of network devices.

In some aspects, the targeted SI update indication may include an indicator that the targeted SI update indication is associated with the one or more subsets of wireless devices. In one aspect, the targeted SI update indication may be transmitted in DCI 1_0 scrambled with a common P-RNTI. At least one of a short message indicator of the DCI 1_0 or at least one bit of a short message of the DCI 1_0 may be the indicator that the targeted SI update indication is associated with the one or more subsets of wireless devices. In one example, reserved bits of the short message of the DCI 1_0 may include a bitmap indicating the one or more subsets of wireless devices associated with the targeted SI update indication, and a presence of the bitmap in the reserved bits of the short message of the DCI 1_0 may be the indicator that the targeted SI update indication is associated with the one or more subsets of wireless devices. In another example, the short message indicator of the DCI 1_0 may be the indicator that the targeted SI update indication is associated with the one or more subsets of wireless devices, where the short message of the DCI 1_0 may include a bitmap indicating the one or more subsets of wireless devices associated with the targeted SI update indication.

In another aspect, the P-RNTI may be a P2-RNTI associated with the one or more subsets of wireless devices, and the P2-RNTI may be the indicator that the targeted SI update indication is associated with the one or more subsets of wireless devices. A short message of the DCI 1_0 scrambled with the P2-RNTI may include a bitmap indicating the one or more subsets of wireless devices associated with the targeted SI update indication. In another aspect, at least one reserved bit of the DCI 1_0 may be the indicator that the targeted SI update indication is associated with the one or more subsets of wireless devices. The network node may transmit an identification of the one or more subsets of wireless devices associated with the targeted SI update indication. In another aspect, the targeted SI update indication for the one or more subsets of wireless devices may be transmitted in a PDSCH or a dedicated group-common PDCCH.

At 1224, the network device may receive the at least one SI update from the network node based on the downlink grant of the at least one SI update associated with the one or more subsets of wireless devices including the wireless device received in the targeted SI update indication at 1220. For example, at 1024, the first network device 1002 may receive the at least one SI update from the network node 1004 based on the downlink grant of the at least one SI update associated with the one or more subsets of wireless devices including the wireless device received in the targeted SI update indication at 1020. Furthermore, 1224 may be performed by the targeted SI indication receiving component 198.

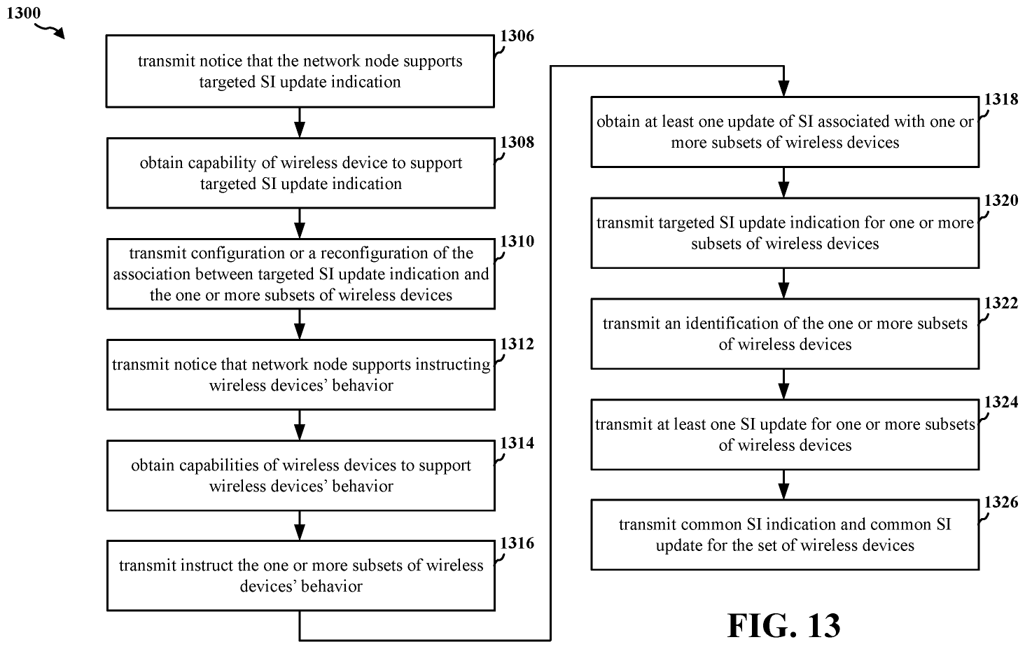

FIG. 13 is a flowchart 1300 of a method of wireless communication. The method may be performed by a network node (e.g., the base station 102; the network entity 1602/1760). The network node may be connected to a network device and transmit a target SI update indication for the one or more subsets of wireless devices among the set of wireless devices associated with the network node or for the subset of directions. The network device of the one or more subsets of wireless devices may receive the target SI update indication and the associated targeted SI update from the network node. The network node and the network device may reduce the overall power consumption by transmitting the targeted SI update indication and the targeted SI update to one or more subsets of network devices relevant to the targeted SI update. Here, the wireless device may include at least one of a user equipment or a child IAB node

The network node and the network device may communicate to each other whether the network node and/or the network device may support the feature of targeted SI update indication.

At 1306, the network node may transmit a notice that the network node may support the targeted SI update indication for the one or more subsets of wireless devices, where the targeted SI update indication may be transmitted for the one or more subsets of wireless devices at 1320 based on the notice that the network node supports the targeted SI update indication for the one or more subsets of wireless devices. For example, at 1006, the network node 1004 may transmit a notice that the network node 1004 may support the targeted SI update indication for the one or more subsets of wireless devices, where the targeted SI update indication may be transmitted for the one or more subsets of wireless devices at 1020 based on the notice that the network node 1004 supports the targeted SI update indication for the one or more subsets of wireless devices. Furthermore, 1306 may be performed by a targeted SI indication transmitting component 199.

At 1308, the network node may obtain capabilities of the one or more subsets of wireless devices to support the targeted SI update indication including a downlink grant of the at least one SI update associated with the one or more subsets of wireless devices, where the targeted SI update indication may be transmitted for the one or more subsets of wireless devices at 1320 based on the obtained capabilities of the one or more subsets of wireless devices. For example, at 1008, the network node 1004 may obtain capabilities of the one or more subsets of wireless devices to support the targeted SI update indication including a downlink grant of the at least one SI update associated with the one or more subsets of wireless devices, where the targeted SI update indication may be transmitted for the one or more subsets of wireless devices at 1020 based on the obtained capabilities of the one or more subsets of wireless devices. Furthermore, 1308 may be performed by the targeted SI indication transmitting component 199.

At 1310, the network node may receive a configuration or a reconfiguration of the association between the targeted SI update indication and the one or more subsets of wireless devices including the wireless device, where the targeted SI update indication may be received from the network node at 1320 based on the configuration or the reconfiguration of the association between the targeted SI update indication and the one or more subsets of wireless devices including the wireless device. The configuration of the targeted SI update indication may further include a mapping of the target group IE blocks to the corresponding bit-fields of the DCI 1_0 identifying the subset of network devices. Based on the configuration, the network node may indicate that the targeted SI update indication is for one or more subsets of wireless devices including the network device, and identify the one or more subsets of wireless devices. The configuration or the reconfiguration of the association between the targeted SI update indication and the one or more subsets of wireless devices may be based on at least one of a direction of the one or more subsets of network devices with respect to the network node, a context of supported features, etc. In one aspect, the configuration or the reconfiguration of the targeted SI update indication, the target group SI blocks, and the corresponding subset of network devices may be explicitly indicated to the set of network devices. The network node may transmit a bitmap or a list of IE indices or names to the set of network devices to indicate the SI IEs associated with each target group SI block. In another aspect, the configuration of the targeted SI update indication, the target group SI blocks, and the corresponding subset of network devices may be implicitly indicated through an association of each target group SI block to a specific feature (e.g., IAB, RedCap, CovEnh, NTN, NES, PS, UAV, etc.). For example, at 1010, the network node 1004 may receive a configuration or a reconfiguration of the association between the targeted SI update indication and the one or more subsets of wireless devices including the wireless device, where the targeted SI update indication may be received from the network node 1004 at 1020 based on the configuration or the reconfiguration of the association between the targeted SI update indication and the one or more subsets of wireless devices including the wireless device. Furthermore, 1310 may be performed by the targeted SI indication transmitting component 199.

At 1312, the network node may transmit a notice that the network node supports instructing the one or more subsets of wireless devices' behavior. For example, at 1012, the network node 1004 may transmit a notice that the network node 1004 supports instructing the one or more subsets of wireless devices' behavior. Furthermore, 1312 may be performed by the targeted SI indication transmitting component 199.

At 1314, the network node may obtain capabilities of the one or more subsets of wireless devices to support the one or more subsets of wireless devices' behavior, where the one or more subsets of wireless devices' behavior is instructed at 1316 based on the obtained capabilities of the one or more subsets of wireless devices. For example, at 1014, the network node 1004 may obtain capabilities of the one or more subsets of wireless devices to support the one or more subsets of wireless devices' behavior, where the one or more subsets of wireless devices' behavior is instructed at 1016 based on the obtained capabilities of the one or more subsets of wireless devices. Furthermore, 1314 may be performed by the targeted SI indication transmitting component 199.

At 1316, the network node may instruct the one or more subsets of wireless devices' behavior to either (A) monitor for DCI 1_0 scrambled with a common P-RNTI and DCI 1_0 scrambled with a P2-RNTI, the common P-RNTI associated with the set of wireless devices, or (B) monitor for DCI 1_0 scrambled with the P2-RNTI. The network device that may support the P2-RNTI (or support multiple P2-RNTIs) may adopt to follow one of following two behaviors. First, the network device may be configured to monitor for the DCI 1_0 scrambled with both P-RNTI and P2-RNTI. Second, the network device may be configured to monitor for the DCI 1_0 scrambled with P2-RNTI. The network node may instruct the network device to select one of the first behavior or the second behavior. Based on the behavior that the network device may follow, the network node may transmit the common SI update in the corresponding manner. For example, at 1016, the network node 1004 may instruct the one or more subsets of wireless devices' behavior to either (A) monitor for DCI 1_0 scrambled with a common P-RNTI and DCI 1_0 scrambled with a P2-RNTI, the common P-RNTI associated with the set of wireless devices, or (B) monitor for DCI 1_0 scrambled with the P2-RNTI. Furthermore, 1316 may be performed by a targeted SI indication transmitting component 199.

At 1318, the network node may obtain at least one update of a SI associated with one or more subsets of wireless devices among a set of wireless devices associated with the network node or a subset of directions from the network node. For example, at 1018, the network node 1004 may obtain at least one update of a SI associated with one or more subsets of wireless devices among a set of wireless devices associated with the network node 1004 or a subset of directions from the network node 1004. Furthermore, 1318 may be performed by the targeted SI indication transmitting component 199.

At 1320, the network node may transmit a targeted SI update indication for the one or more subsets of wireless devices among the set of wireless devices associated with the network node or for the subset of directions, the targeted SI update indication including a downlink grant of the at least one SI update associated with the one or more subsets of wireless devices or the subset of directions as obtained at 1318. For example, at 1020, the network node 1004 may transmit a targeted SI update indication for the one or more subsets of wireless devices among the set of wireless devices associated with the network node 1004 or for the subset of directions, the targeted SI update indication including a downlink grant of the at least one SI update associated with the one or more subsets of wireless devices or the subset of directions as obtained at 1018. Furthermore, 1320 may be performed by the targeted SI indication transmitting component 199.

In one aspect, the targeted SI update indication may be for the subset of directions and is output for transmission in the subset of directions. That is, some parameters of SI may be beam-specific (e.g., transmit-receive point (TRP)-specific), and update to the beam-specific SI may be relevant to a direction with respect to the network node and the SI configuration and update may be relevant to the direction of the one or more subsets of network devices with respect to the network node. Here, the targeted SI update may be relevant to the network device but not relevant to another network device that is not in the one or more subsets of network devices.

In some aspects, the targeted SI update indication may include an indicator that the targeted SI update indication is associated with the one or more subsets of wireless devices. In one aspect, the targeted SI update indication may be transmitted in DCI 1_0 scrambled with a common P-RNTI. At least one of a short message indicator of the DCI 1_0 or at least one bit of a short message of the DCI 1_0 may be the indicator that the targeted SI update indication is associated with the one or more subsets of wireless devices. In one example, reserved bits of the short message of the DCI 1_0 may include a bitmap indicating the one or more subsets of wireless devices associated with the targeted SI update indication, and a presence of the bitmap in the reserved bits of the short message of the DCI 1_0 may be the indicator that the targeted SI update indication is associated with the one or more subsets of wireless devices. In another example, the short message indicator of the DCI 1_0 may be the indicator that the targeted SI update indication is associated with the one or more subsets of wireless devices, where the short message of the DCI 1_0 may include a bitmap indicating the one or more subsets of wireless devices associated with the targeted SI update indication.

In another aspect, the P-RNTI may be a P2-RNTI associated with the one or more subsets of wireless devices, and the P2-RNTI may be the indicator that the targeted SI update indication is associated with the one or more subsets of wireless devices. A short message of the DCI 1_0 scrambled with the P2-RNTI may include a bitmap indicating the one or more subsets of wireless devices associated with the targeted SI update indication. In another aspect, at least one reserved bit of the DCI 1_0 may be the indicator that the targeted SI update indication is associated with the one or more subsets of wireless devices. The network node may transmit an identification of the one or more subsets of wireless devices associated with the targeted SI update indication at 1122. In another aspect, the targeted SI update indication for the one or more subsets of wireless devices may be transmitted in a PDSCH or a dedicated group-common PDCCH.

At 1322, based on at least one reserved bit of the DCI 1_0 being the indicator that the targeted SI update indication is associated with the one or more subsets of wireless devices, the network node may transmit an identification of the one or more subsets of wireless devices associated with the targeted SI update indication. In one aspect, the identification of the one or more subsets of wireless devices associated with the targeted SI update indication may be transmitted in a second DCI 1_0 scrambled with a P2-RNTI associated with the one or more subsets of wireless devices, a short message of the second DCI 1_0 including the bitmap indicating the one or more subsets of wireless devices associated with the targeted SI update indication. In another aspect, the identification of the one or more subsets of wireless devices associated with the targeted SI update indication may be transmitted in a downlink payload associated with the downlink grant of the SI in the targeted SI update indication, the downlink payload including the bitmap indicating the one or more subsets of wireless devices associated with the targeted SI update indication. For example, at 1022, based on at least one reserved bit of the DCI 1_0 being the indicator that the targeted SI update indication is associated with the one or more subsets of wireless devices, the network node 1004 may transmit an identification of the one or more subsets of wireless devices associated with the targeted SI update indication. Furthermore, 1322 may be performed by the targeted SI indication transmitting component 199.

At 1324, the network node may transmit at least one SI update for the one or more subsets of wireless devices based on the downlink grant of the at least one SI update associated with the one or more subsets of wireless devices in the targeted SI update indication at 1320. For example, at 1024, the network node 1004 may transmit at least one SI update for the one or more subsets of wireless devices based on the downlink grant of the at least one SI update associated with the one or more subsets of wireless devices in the targeted SI update indication at 1020. Furthermore, 1324 may be performed by the targeted SI indication transmitting component 199.

At 1326, the network node may transmit a common SI indication for the set of wireless devices associated with the network node. In one aspect, the common SI indication for the set of wireless devices associated with the network node may be transmitted in a common DCI 1_0 scrambled with the common P-RNTI based on instructing the one or more subsets of wireless devices to monitor for common DCI 1_0 scrambled with a common P-RNTI and DCI 1_0 scrambled with the P2-RNTI, where the common SI indication including a downlink grant of a common SI update associated with the set of wireless devices. That is, the network node may transmit the common SI indicator for the first network node and the second network node in a common DCI 1_0 scrambled with the common P-RNTI based on instructing the one or more subsets of wireless devices to monitor for common DCI 1_0 scrambled with a common P-RNTI and DCI 1_0 scrambled with the P2-RNTI, where the common SI indication including a downlink grant of a common SI update associated with the set of wireless devices. In another aspect, the common SI indication for the set of wireless devices associated with the network node may be transmitted in (A) a first common DCI 1_0 scrambled with the P2-RNTI for the one or more subsets of wireless devices, and (B) a second common DCI 1_0 scrambled with a common P-RNTI for wireless devices of the set of wireless devices other than the one or more subsets of wireless devices, based on instructing the one or more subsets of wireless devices to monitor for the DCI 1_0 scrambled with the P2-RNTI. That is, the network node may transmit the common SI indicator to the network device in a first common DCI 1_0 scrambled with the P2-RNTI for the one or more subsets of wireless devices, and to other network device in a second common DCI 1_0 scrambled with a common P-RNTI for wireless devices of the set of wireless devices other than the one or more subsets of wireless devices. For example, at 1026, the network node 1004 may transmit a common SI indication for the set of wireless devices associated with the network node 1004. Furthermore, 1326 may be performed by a targeted SI indication transmitting component 199.

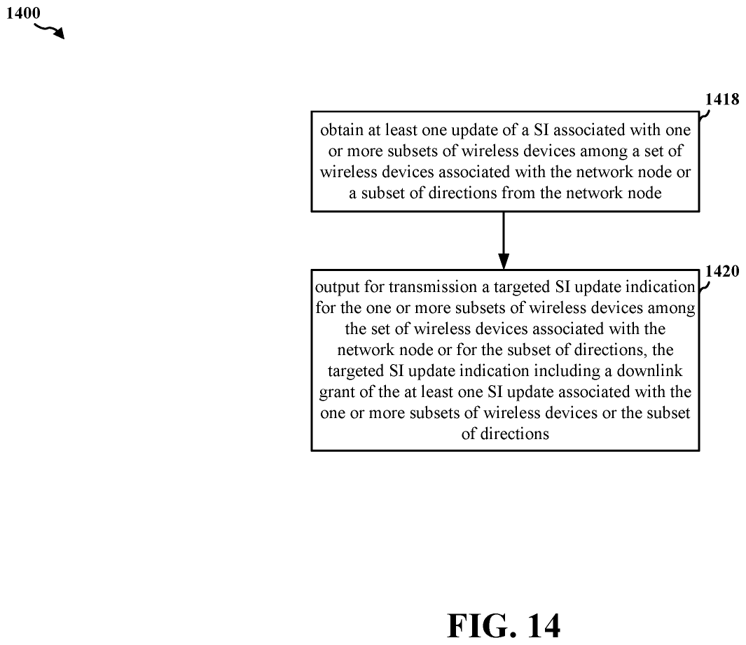

FIG. 14 is a flowchart 1400 of a method of wireless communication. The method may be performed by a network node (e.g., the base station 102; the network entity 1602/1760). The network node may be connected to a network device and transmit a target SI update indication for the one or more subsets of wireless devices among the set of wireless devices associated with the network node or for the subset of directions. The network device of the one or more subsets of wireless devices may receive the target SI update indication and the associated targeted SI update from the network node. The network node and the network device may reduce the overall power consumption by transmitting the targeted SI update indication and the targeted SI update to one or more subsets of network devices relevant to the targeted SI update. Here, the wireless device may include at least one of a user equipment or a child IAB node

The network node and the network device may communicate to each other whether the network node and/or the network device may support the feature of targeted SI update indication.

At 1418, the network node may obtain at least one update of a SI associated with one or more subsets of wireless devices among a set of wireless devices associated with the network node or a subset of directions from the network node. For example, at 1018, the network node 1004 may obtain at least one update of a SI associated with one or more subsets of wireless devices among a set of wireless devices associated with the network node 1004 or a subset of directions from the network node 1004. Furthermore, 1418 may be performed by the targeted SI indication transmitting component 199.

At 1420, the network node may transmit a targeted SI update indication for the one or more subsets of wireless devices among the set of wireless devices associated with the network node or for the subset of directions, the targeted SI update indication including a downlink grant of the at least one SI update associated with the one or more subsets of wireless devices or the subset of directions as obtained at 1418. For example, at 1020, the network node 1004 may transmit a targeted SI update indication for the one or more subsets of wireless devices among the set of wireless devices associated with the network node 1004 or for the subset of directions, the targeted SI update indication including a downlink grant of the at least one SI update associated with the one or more subsets of wireless devices or the subset of directions as obtained at 1018. Furthermore, 1420 may be performed by the targeted SI indication transmitting component 199.

In one aspect, the targeted SI update indication may be for the subset of directions and is output for transmission in the subset of directions. That is, some parameters of SI may be beam-specific (e.g., transmit-receive point (TRP)-specific), and update to the beam-specific SI may be relevant to a direction with respect to the network node and the SI configuration and update may be relevant to the direction of the one or more subsets of network devices with respect to the network node. Here, the targeted SI update may be relevant to the network device but not relevant to another network device that is not in the one or more subsets of network devices.

In some aspects, the targeted SI update indication may include an indicator that the targeted SI update indication is associated with the one or more subsets of wireless devices. In one aspect, the targeted SI update indication may be transmitted in DCI 1_0 scrambled with a common P-RNTI. At least one of a short message indicator of the DCI 1_0 or at least one bit of a short message of the DCI 1_0 may be the indicator that the targeted SI update indication is associated with the one or more subsets of wireless devices. In one example, reserved bits of the short message of the DCI 1_0 may include a bitmap indicating the one or more subsets of wireless devices associated with the targeted SI update indication, and a presence of the bitmap in the reserved bits of the short message of the DCI 1_0 may be the indicator that the targeted SI update indication is associated with the one or more subsets of wireless devices. In another example, the short message indicator of the DCI 1_0 may be the indicator that the targeted SI update indication is associated with the one or more subsets of wireless devices, where the short message of the DCI 1_0 may include a bitmap indicating the one or more subsets of wireless devices associated with the targeted SI update indication.

In another aspect, the P-RNTI may be a P2-RNTI associated with the one or more subsets of wireless devices, and the P2-RNTI may be the indicator that the targeted SI update indication is associated with the one or more subsets of wireless devices. A short message of the DCI 1_0 scrambled with the P2-RNTI may include a bitmap indicating the one or more subsets of wireless devices associated with the targeted SI update indication. In another aspect, at least one reserved bit of the DCI 1_0 may be the indicator that the targeted SI update indication is associated with the one or more subsets of wireless devices. The network node may transmit an identification of the one or more subsets of wireless devices associated with the targeted SI update indication at 1122. In another aspect, the targeted SI update indication for the one or more subsets of wireless devices may be transmitted in a PDSCH or a dedicated group-common PDCCH.

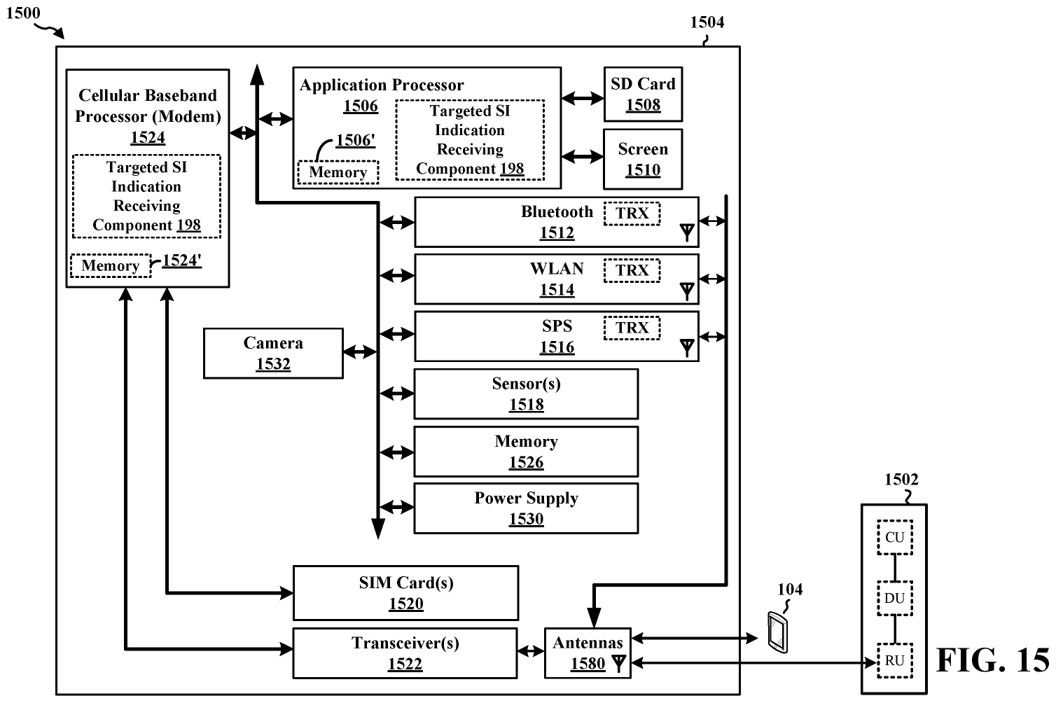

FIG. 15 is a diagram 1500 illustrating an example of a hardware implementation for an apparatus 1504. The apparatus 1504 may be a UE or a IAB child node, a component of a UE or a IAB child node, or may implement UE or IAB child node functionality. In some aspects, the apparatus 1504 may include a cellular baseband processor 1524 (also referred to as a modem) coupled to one or more transceivers 1522 (e.g., cellular RF transceiver). The cellular baseband processor 1524 may include on-chip memory 1524′. In some aspects, the apparatus 1504 may further include one or more subscriber identity modules (SIM) cards 1520 and an application processor 1506 coupled to a secure digital (SD) card 1508 and a screen 1510. The application processor 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor 1524 communicates through the transceiver(s) 1522 via one or more antennas 1580 with the UE 104 and/or with an RU associated with a network entity 1502. The cellular baseband processor 1524 and the application processor 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor 1524 and the application processor 1506 are each responsible for general processing, including the execution of software stored on the computer-readable medium/memory. The software, when executed by the cellular baseband processor 1524/application processor 1506, causes the cellular baseband processor 1524/application processor 1506 to perform the various functions described supra. The computer-readable medium/memory may also be used for storing data that is manipulated by the cellular baseband processor 1524/application processor 1506 when executing software. The cellular baseband processor 1524/application processor 1506 may be a component of the UE 350 and may include the memory 360 and/or at least one of the TX processor 368, the RX processor 356, and the controller/processor 359. In one configuration, the apparatus 1504 may be a processor chip (modem and/or application) and include just the cellular baseband processor 1524 and/or the application processor 1506, and in another configuration, the apparatus 1504 may be the entire UE (e.g., see 350 of FIG. 3) and include the additional modules of the apparatus 1504.

As discussed supra, the targeted SI indication receiving component 198 is configured to receive a targeted SI update indication for one or more subsets of wireless devices including the wireless device from a network node, the targeted SI update indication including a downlink grant of at least one SI update associated with the one or more subsets of wireless devices of a set of wireless devices, and receive the at least one SI update from the network node based on the downlink grant of the at least one SI update associated with the one or more subsets of wireless devices including the wireless device. The targeted SI indication receiving component 198 may be within the cellular baseband processor 1524, the application processor 1506, or both the cellular baseband processor 1524 and the application processor 1506. The targeted SI indication receiving component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1504 may include a variety of components configured for various functions. In one configuration, the apparatus 1504, and in particular the cellular baseband processor 1524 and/or the application processor 1506, includes means for receiving a targeted SI update indication for one or more subsets of wireless devices including the wireless device from a network node, the targeted SI update indication including a downlink grant of at least one SI update associated with the one or more subsets of wireless devices of a set of wireless devices, and means for receiving the at least one SI update from the network node based on the downlink grant of the at least one SI update associated with the one or more subsets of wireless devices including the wireless device. In one configuration, the targeted SI update indication includes an indicator that the targeted SI update indication is associated with the one or more subsets of wireless devices including the wireless device, and where the targeted SI update indication is received in DCI 1_0 scrambled with a P-RNTI. In one configuration, at least one of a short message indicator of the DCI 1_0 or at least one bit of a short message of the DCI 1_0 is the indicator that the targeted SI update indication is associated with the one or more subsets of wireless devices including the wireless device. In one configuration, reserved bits of the short message of the DCI 1_0 includes a bitmap indicating the one or more subsets of wireless devices associated with the targeted SI update indication, and a presence of the bitmap in the reserved bits of the short message of the DCI 1_0 is the indicator that the targeted SI update indication is associated with the one or more subsets of wireless devices including the wireless device. In one configuration, the short message indicator of the DCI 1_0 is the indicator that the targeted SI update indication is associated with the one or more subsets of wireless devices including the wireless device, where the short message of the DCI 1_0 includes a bitmap indicating the one or more subsets of wireless devices associated with the targeted SI update indication. the P-RNTI is a P2_RNTI associated with the one or more subsets of wireless devices including the wireless device, and the P2-RNTI is the indicator that the targeted SI update indication is associated with the one or more subsets of wireless devices including the wireless device, and where a short message of the DCI 1_0 scrambled with the P2-RNTI includes a bitmap indicating the one or more subsets of wireless devices associated with the targeted SI update indication. In one configuration, at least one reserved bit of the DCI 1_0 is the indicator that the targeted SI update indication is associated with the one or more subsets of wireless devices including the wireless device, where the at least one processor is further configured to receive an identification of the one or more subsets of wireless devices associated with the targeted SI update indication. In one configuration, the identification of the one or more subsets of wireless devices associated with the targeted SI update indication is received in at least one of a second DCI 1_0 scrambled with a P2_RNTI associated with the one or more subsets of wireless devices including the wireless device, a short message of the second DCI 1_0 including a bitmap indicating the one or more subsets of wireless devices associated with the targeted SI update indication, or a downlink payload associated with the downlink grant of the SI in the targeted SI update indication, the downlink payload including the bitmap indicating the one or more subsets of wireless devices associated with the targeted SI update indication. In one configuration, the apparatus 1504, and in particular the cellular baseband processor 1524 and/or the application processor 1506, further includes means for receiving a configuration or a reconfiguration of the association between the targeted SI update indication and the one or more subsets of wireless devices including the wireless device, where the targeted SI update indication is received from the network node based on the configuration or the reconfiguration of the association between the targeted SI update indication and the one or more subsets of wireless devices including the wireless device. In one configuration, the apparatus 1504, and in particular the cellular baseband processor 1524 and/or the application processor 1506, further includes receiving a notice that the network node supports the targeted SI update indication for the one or more subsets of wireless devices from the network node, or means for transmitting capabilities of the one or more subsets of wireless devices to support the targeted SI update indication including a downlink grant of the at least one SI update associated with the one or more subsets of wireless devices, where the targeted SI update indication is received from the network node based on the notice that the network node supports the targeted SI update indication for the one or more subsets of wireless devices or the capabilities of the wireless device transmitted to the network node. In one configuration, the apparatus 1504, and in particular the cellular baseband processor 1524 and/or the application processor 1506, further includes means for receiving an instruction of a wireless device's behavior to either (A) monitor for DCI 1_0 scrambled with a common P-RNTI and DCI 1_0 scrambled with a P2_RNTI, the common P-RNTI associated with a set of wireless devices, or (B) monitor for DCI 1_0 scrambled with the P2-RNTI. In one configuration, the apparatus 1504, and in particular the cellular baseband processor 1524 and/or the application processor 1506, further includes means for receiving a notice that the network node supports instructing the wireless device's behavior, or means for transmitting a capability of the wireless device to support the wireless device's behavior, where the wireless device's behavior is instructed based on the capability of the wireless devices. In one configuration, the targeted SI update indication for the one or more subsets of wireless devices is received in a PDSCH or a dedicated group-common PDCCH. The means may be the targeted SI indication receiving component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

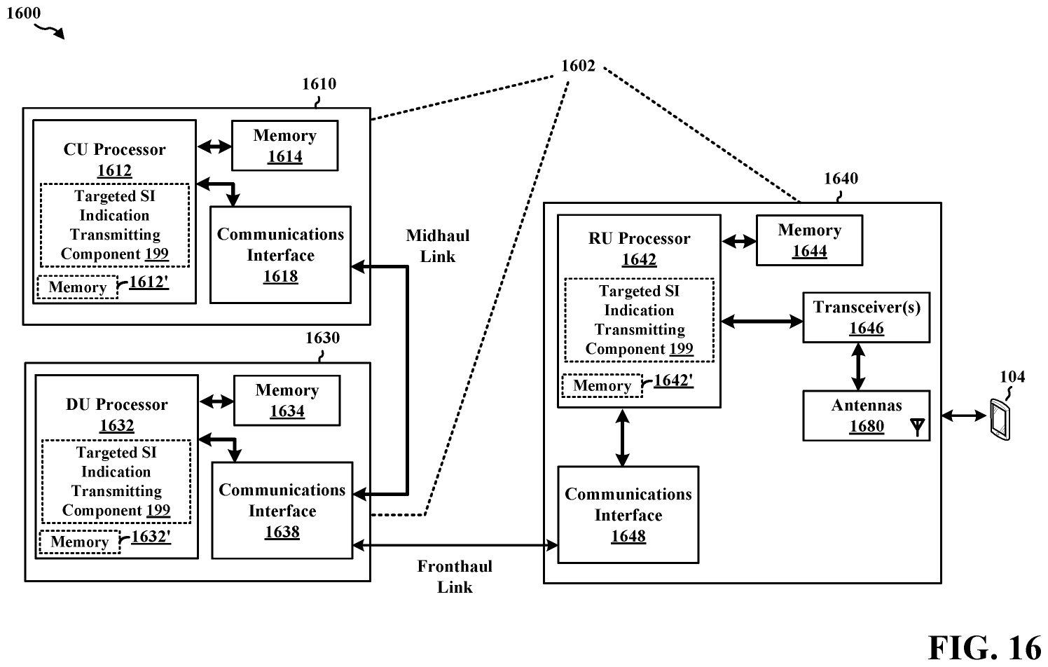

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the targeted SI indication transmitting component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include a CU processor 1612. The CU processor 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include a DU processor 1632. The DU processor 1632 may include on-chip memory 1632′. In some aspects, the DU 1630 may further include additional memory modules 1634 and a communications interface 1638. The DU 1630 communicates with the RU 1640 through a fronthaul link. The RU 1640 may include an RU processor 1642. The RU processor 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the targeted SI indication transmitting component 199 is configured to obtain at least one update of a SI associated with one or more subsets of wireless devices among a set of wireless devices associated with the network node or a subset of directions from the network node, and output for transmission a targeted SI update indication for the one or more subsets of wireless devices among the set of wireless devices associated with the network node or for the subset of directions, the targeted SI update indication including a downlink grant of the at least one SI update associated with the one or more subsets of wireless devices or the subset of directions. The targeted SI indication transmitting component 199 may be within one or more processors of one or more of the CU 1610, DU 1630, and the RU 1640. The targeted SI indication transmitting component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1602 may include a variety of components configured for various functions. In one configuration, the network entity 1602 includes means for obtaining at least one update of a SI associated with one or more subsets of wireless devices among a set of wireless devices associated with the network node or a subset of directions from the network node, and means for outputting for transmission a targeted SI update indication for the one or more subsets of wireless devices among the set of wireless devices associated with the network node or for the subset of directions, the targeted SI update indication including a downlink grant of the at least one SI update associated with the one or more subsets of wireless devices or the subset of directions. In one configuration, the at least on processor is further configured to output for transmission the at least one SI update for the one or more subsets of wireless devices based on the downlink grant of the at least one SI update associated with the one or more subsets of wireless devices, where the subset of wireless devices includes at least one of a user equipment or a child IAB node. In one configuration, the targeted SI update indication is for the subset of directions and is output for transmission in the subset of directions. In one configuration, the targeted SI update indication includes an indicator that the targeted SI update indication is associated with the one or more subsets of wireless devices, and where the targeted SI update indication is output for transmission in DCI 1_0 scrambled with a P-RNTI. In one configuration, at least one of a short message indicator of the DCI 1_0 or at least one bit of a short message of the DCI 1_0 is the indicator that the targeted SI update indication is associated with the one or more subsets of wireless devices. In one configuration, reserved bits of the short message of the DCI 1_0 includes a bitmap indicating the one or more subsets of wireless devices associated with the targeted SI update indication, and a presence of the bitmap in the reserved bits of the short message of the DCI 1_0 is the indicator that the targeted SI update indication is associated with the one or more subsets of wireless devices. In one configuration, the short message indicator of the DCI 1_0 is the indicator that the targeted SI update indication is associated with the one or more subsets of wireless devices, where the short message of the DCI 1_0 includes a bitmap indicating the one or more subsets of wireless devices associated with the targeted SI update indication. In one configuration, the P-RNTI is a P2_RNTI associated with the one or more subsets of wireless devices, and the P2-RNTI is the indicator that the targeted SI update indication is associated with the one or more subsets of wireless devices, and where a short message of the DCI 1_0 scrambled with the P2-RNTI includes a bitmap indicating the one or more subsets of wireless devices associated with the targeted SI update indication. In one configuration, at least one reserved bit of the DCI 1_0 is the indicator that the targeted SI update indication is associated with the one or more subsets of wireless devices, where the at least one processor is further configured to output for transmission an identification of the one or more subsets of wireless devices associated with the targeted SI update indication. In one configuration, the identification of the one or more subsets of wireless devices associated with the targeted SI update indication is output for transmission in at least one of a second DCI 1_0 scrambled with a P2_RNTI associated with the one or more subsets of wireless devices, a short message of the second DCI 1_0 including a bitmap indicating the one or more subsets of wireless devices associated with the targeted SI update indication, or a downlink payload associated with the downlink grant of the SI in the targeted SI update indication, the downlink payload including the bitmap indicating the one or more subsets of wireless devices associated with the targeted SI update indication. In one configuration, the network entity 1602 further includes means for outputting for transmission a configuration or a reconfiguration of the association between the targeted SI update indication and the one or more subsets of wireless devices, where the targeted SI update indication is output for transmission for the one or more subsets of wireless devices based on the configuration or the reconfiguration of the association between the targeted SI update indication and the one or more subsets of wireless devices. In one configuration, the network entity 1602 further includes means for outputting for transmission a notice that the network node supports the targeted SI update indication for the one or more subsets of wireless devices, or means for obtaining capabilities of the one or more subsets of wireless devices to support the targeted SI update indication including a downlink grant of the at least one SI update associated with the one or more subsets of wireless devices, where the targeted SI update indication is output for transmission for the one or more subsets of wireless devices based on the notice that the network node supports the targeted SI update indication for the one or more subsets of wireless devices or the obtained capabilities of the one or more subsets of wireless devices. In one configuration, the network entity 1602 further includes means for instructing the one or more subsets of wireless devices' behavior to either (A) monitor for DCI 1_0 scrambled with a common P-RNTI and DCI 1_0 scrambled with a P2_RNTI, the common P-RNTI associated with the set of wireless devices, or (B) monitor for DCI 1_0 scrambled with the P2-RNTI. In one configuration, the network entity 1602 further includes means for outputting for transmission a notice that the network node supports instructing the one or more subsets of wireless devices' behavior, or means for obtaining capabilities of the one or more subsets of wireless devices to support the one or more subsets of wireless devices' behavior, where the one or more subsets of wireless devices' behavior is instructed based on the obtained capabilities of the one or more subsets of wireless devices. In one configuration, the targeted SI update indication for the one or more subsets of wireless devices is output for transmission in a PDSCH or a dedicated group-common PDCCH. The means may be the targeted SI indication transmitting component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

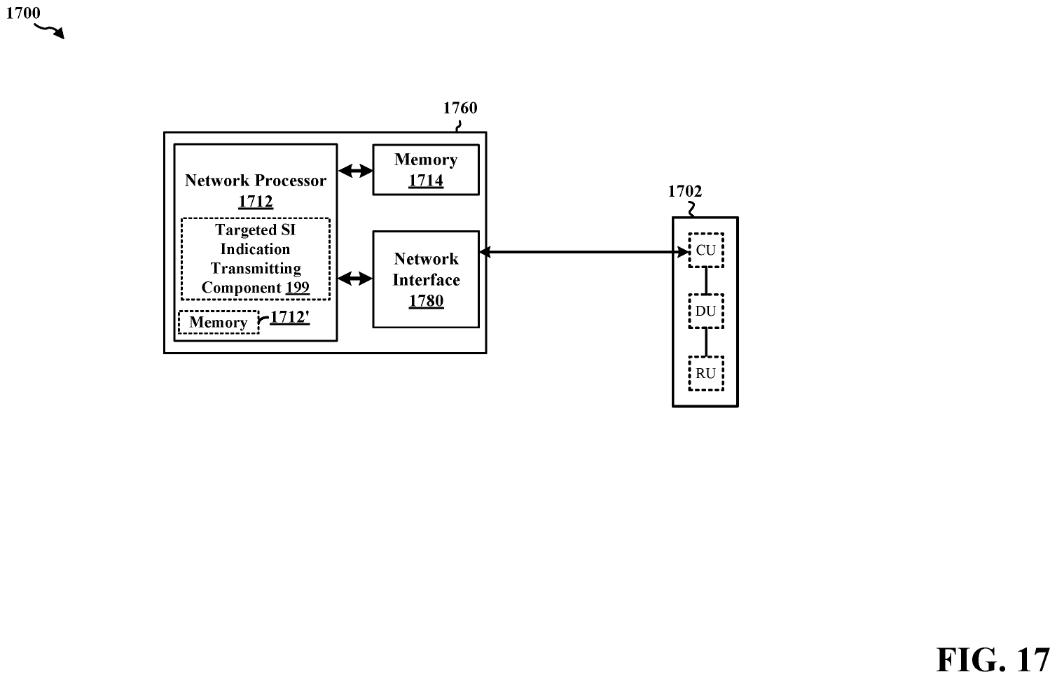

FIG. 17 is a diagram 1700 illustrating an example of a hardware implementation for a network entity 1760. In one example, the network entity 1760 may be within the core network 120. The network entity 1760 may include a network processor 1712. The network processor 1712 may include on-chip memory 1712′. In some aspects, the network entity 1760 may further include additional memory modules 1714. The network entity 1760 communicates via the network interface 1780 directly (e.g., backhaul link) or indirectly (e.g., through a RIC) with the CU 1702. The on-chip memory 1712′ and the additional memory modules 1714 may each be considered a computer-readable medium/memory. Each computer-readable medium/memory may be non-transitory. The processor 1712 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the targeted SI indication transmitting component 199 is configured to obtain at least one update of a SI associated with one or more subsets of wireless devices among a set of wireless devices associated with the network node or a subset of directions from the network node, and output for transmission a targeted SI update indication for the one or more subsets of wireless devices among the set of wireless devices associated with the network node or for the subset of directions, the targeted SI update indication including a downlink grant of the at least one SI update associated with the one or more subsets of wireless devices or the subset of directions. The targeted SI indication transmitting component 199 may be within the processor 1712. The targeted SI indication transmitting component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1760 may include a variety of components configured for various functions. In one configuration, the network entity 1760 includes means for obtaining at least one update of a SI associated with one or more subsets of wireless devices among a set of wireless devices associated with the network node or a subset of directions from the network node, and means for outputting for transmission a targeted SI update indication for the one or more subsets of wireless devices among the set of wireless devices associated with the network node or for the subset of directions, the targeted SI update indication including a downlink grant of the at least one SI update associated with the one or more subsets of wireless devices or the subset of directions. In one configuration, the at least on processor is further configured to output for transmission the at least one SI update for the one or more subsets of wireless devices based on the downlink grant of the at least one SI update associated with the one or more subsets of wireless devices, where the subset of wireless devices includes at least one of a user equipment or a child IAB node. In one configuration, the targeted SI update indication is for the subset of directions and is output for transmission in the subset of directions. In one configuration, the targeted SI update indication includes an indicator that the targeted SI update indication is associated with the one or more subsets of wireless devices, and where the targeted SI update indication is output for transmission in DCI 1_0 scrambled with a P-RNTI. In one configuration, at least one of a short message indicator of the DCI 1_0 or at least one bit of a short message of the DCI 1_0 is the indicator that the targeted SI update indication is associated with the one or more subsets of wireless devices. In one configuration, reserved bits of the short message of the DCI 1_0 includes a bitmap indicating the one or more subsets of wireless devices associated with the targeted SI update indication, and a presence of the bitmap in the reserved bits of the short message of the DCI 1_0 is the indicator that the targeted SI update indication is associated with the one or more subsets of wireless devices. In one configuration, the short message indicator of the DCI 1_0 is the indicator that the targeted SI update indication is associated with the one or more subsets of wireless devices, where the short message of the DCI 1_0 includes a bitmap indicating the one or more subsets of wireless devices associated with the targeted SI update indication. In one configuration, the P-RNTI is a P2_RNTI associated with the one or more subsets of wireless devices, and the P2-RNTI is the indicator that the targeted SI update indication is associated with the one or more subsets of wireless devices, and where a short message of the DCI 1_0 scrambled with the P2-RNTI includes a bitmap indicating the one or more subsets of wireless devices associated with the targeted SI update indication. In one configuration, at least one reserved bit of the DCI 1_0 is the indicator that the targeted SI update indication is associated with the one or more subsets of wireless devices, where the at least one processor is further configured to output for transmission an identification of the one or more subsets of wireless devices associated with the targeted SI update indication. In one configuration, the identification of the one or more subsets of wireless devices associated with the targeted SI update indication is output for transmission in at least one of a second DCI 1_0 scrambled with a P2_RNTI associated with the one or more subsets of wireless devices, a short message of the second DCI 1_0 including a bitmap indicating the one or more subsets of wireless devices associated with the targeted SI update indication, or a downlink payload associated with the downlink grant of the SI in the targeted SI update indication, the downlink payload including the bitmap indicating the one or more subsets of wireless devices associated with the targeted SI update indication. In one configuration, the network entity 1760 further includes means for outputting for transmission a configuration or a reconfiguration of the association between the targeted SI update indication and the one or more subsets of wireless devices, where the targeted SI update indication is output for transmission for the one or more subsets of wireless devices based on the configuration or the reconfiguration of the association between the targeted SI update indication and the one or more subsets of wireless devices. In one configuration, the network entity 1760 further includes means for outputting for transmission a notice that the network node supports the targeted SI update indication for the one or more subsets of wireless devices, or means for obtaining capabilities of the one or more subsets of wireless devices to support the targeted SI update indication including a downlink grant of the at least one SI update associated with the one or more subsets of wireless devices, where the targeted SI update indication is output for transmission for the one or more subsets of wireless devices based on the notice that the network node supports the targeted SI update indication for the one or more subsets of wireless devices or the obtained capabilities of the one or more subsets of wireless devices. In one configuration, the network entity 1760 further includes means for instructing the one or more subsets of wireless devices' behavior to either (A) monitor for DCI 1_0 scrambled with a common P-RNTI and DCI 1_0 scrambled with a P2_RNTI, the common P-RNTI associated with the set of wireless devices, or (B) monitor for DCI 1_0 scrambled with the P2-RNTI. In one configuration, the network entity 1760 further includes means for outputting for transmission a notice that the network node supports instructing the one or more subsets of wireless devices' behavior, or means for obtaining capabilities of the one or more subsets of wireless devices to support the one or more subsets of wireless devices' behavior, where the one or more subsets of wireless devices' behavior is instructed based on the obtained capabilities of the one or more subsets of wireless devices. In one configuration, the targeted SI update indication for the one or more subsets of wireless devices is output for transmission in a PDSCH or a dedicated group-common PDCCH. The means may be the targeted SI indication transmitting component 199 of the network entity 1760 configured to perform the functions recited by the means.

Based on some aspects of the current disclosure, a network node may obtain at least one update of a SI associated with one or more subsets of wireless devices among a set of wireless devices associated with the network node or a subset of directions from the network node, and transmit a targeted SI update indication for the one or more subsets of wireless devices among the set of wireless devices associated with the network node or for the subset of directions, the targeted SI update indication including a downlink grant of the at least one SI update associated with the one or more subsets of wireless devices or the subset of directions. A network device of the subset of network devices may receive a targeted SI update indication for one or more subsets of wireless devices including the wireless device from a network node, the targeted SI update indication including a downlink grant of at least one SI update associated with the one or more subsets of wireless devices of a set of wireless devices and receive the at least one SI update from the network node based on the downlink grant of the at least one SI update associated with the one or more subsets of wireless devices including the wireless device. In one aspect, the targeted SI update indication is for the subset of directions. In another aspect, the targeted SI update indication includes an indicator that the targeted SI update indication is associated with the one or more subsets of wireless devices. Accordingly, the network node may transmit the targeted SI update indication to the one or more subset of network devices, and the network devices other than the one or more subsets of network devices do not need to receive the targeted SI update, reducing the overall power consumption for transmitting the targeted SI update indication and the targeted SI update.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a network node, including obtaining at least one update of a SI associated with one or more subsets of wireless devices among a set of wireless devices associated with the network node or a subset of directions from the network node, and outputting for transmission a targeted SI update indication for the one or more subsets of wireless devices among the set of wireless devices associated with the network node or for the subset of directions, the targeted SI update indication including a downlink grant of the at least one SI update associated with the one or more subsets of wireless devices or the subset of directions.

Aspect 2 is the method of aspect 1, where the at least on processor is further configured to output for transmission the at least one SI update for the one or more subsets of wireless devices based on the downlink grant of the at least one SI update associated with the one or more subsets of wireless devices, where the subset of wireless devices includes at least one of a user equipment or a child IAB node.

Aspect 3 is the method of any of aspects 1 and 2, where the targeted SI update indication is for the subset of directions and is output for transmission in the subset of directions.

Aspect 4 is the method of any of aspects 1 to 3, where the targeted SI update indication includes an indicator that the targeted SI update indication is associated with the one or more subsets of wireless devices, and where the targeted SI update indication is output for transmission in DCI 1_0 scrambled with a P-RNTI.

Aspect 5 is the method of aspect 4, where at least one of a short message indicator of the DCI 1_0 or at least one bit of a short message of the DCI 1_0 is the indicator that the targeted SI update indication is associated with the one or more subsets of wireless devices.

Aspect 6 is the method of aspect 5, where reserved bits of the short message of the DCI 1_0 includes a bitmap indicating the one or more subsets of wireless devices associated with the targeted SI update indication, and a presence of the bitmap in the reserved bits of the short message of the DCI 1_0 is the indicator that the targeted SI update indication is associated with the one or more subsets of wireless devices.

Aspect 7 is the method of any of aspects 5 and 6, where the short message indicator of the DCI 1_0 is the indicator that the targeted SI update indication is associated with the one or more subsets of wireless devices, where the short message of the DCI 1_0 includes a bitmap indicating the one or more subsets of wireless devices associated with the targeted SI update indication.

Aspect 8 is the method of any of aspects 4 to 7, where the P-RNTI is a P2_RNTI associated with the one or more subsets of wireless devices, and the P2-RNTI is the indicator that the targeted SI update indication is associated with the one or more subsets of wireless devices, and where a short message of the DCI 1_0 scrambled with the P2-RNTI includes a bitmap indicating the one or more subsets of wireless devices associated with the targeted SI update indication.

Aspect 9 is the method of any of aspects 4 to 8, where at least one reserved bit of the DCI 1_0 is the indicator that the targeted SI update indication is associated with the one or more subsets of wireless devices, where the at least one processor is further configured to output for transmission an identification of the one or more subsets of wireless devices associated with the targeted SI update indication.

Aspect 10 is the method of aspect 9, where the identification of the one or more subsets of wireless devices associated with the targeted SI update indication is output for transmission in at least one of a second DCI 1_0 scrambled with a P2_RNTI associated with the one or more subsets of wireless devices, a short message of the second DCI 1_0 including a bitmap indicating the one or more subsets of wireless devices associated with the targeted SI update indication, or a downlink payload associated with the downlink grant of the SI in the targeted SI update indication, the downlink payload including the bitmap indicating the one or more subsets of wireless devices associated with the targeted SI update indication.

Aspect 11 is the method of any of aspects 1 to 10, further including outputting for transmission a configuration or a reconfiguration of the association between the targeted SI update indication and the one or more subsets of wireless devices, where the targeted SI update indication is output for transmission for the one or more subsets of wireless devices based on the configuration or the reconfiguration of the association between the targeted SI update indication and the one or more subsets of wireless devices.

Aspect 12 is the method of any of aspects 1 to 11, further including outputting for transmission a notice that the network node supports the targeted SI update indication for the one or more subsets of wireless devices, or obtaining capabilities of the one or more subsets of wireless devices to support the targeted SI update indication including a downlink grant of the at least one SI update associated with the one or more subsets of wireless devices, where the targeted SI update indication is output for transmission for the one or more subsets of wireless devices based on the notice that the network node supports the targeted SI update indication for the one or more subsets of wireless devices or the obtained capabilities of the one or more subsets of wireless devices.

Aspect 13 is the method of any of aspects 1 to 12, further including instructing the one or more subsets of wireless devices' behavior to either (A) monitor for DCI 1_0 scrambled with a common P-RNTI and DCI 1_0 scrambled with a P2_RNTI, the common P-RNTI associated with the set of wireless devices, or (B) monitor for DCI 1_0 scrambled with the P2-RNTI.

Aspect 14 is the method of aspect 13, further including outputting for transmission a notice that the network node supports instructing the one or more subsets of wireless devices' behavior, or obtaining capabilities of the one or more subsets of wireless devices to support the one or more subsets of wireless devices' behavior, where the one or more subsets of wireless devices' behavior is instructed based on the obtained capabilities of the one or more subsets of wireless devices.

Aspect 15 is the method of any of aspects 1 to 14, where the targeted SI update indication for the one or more subsets of wireless devices is output for transmission in a PDSCH or a dedicated group-common PDCCH.

Aspect 16 is an apparatus for wireless communication including at least one processor coupled to a memory and configured to implement any of aspects 1 to 15, further including a transceiver coupled to the at least one processor.

Aspect 17 is an apparatus for wireless communication including means for implementing any of aspects 1 to 15.

Aspect 18 is a non-transitory computer-readable medium storing computer executable code, where the code when executed by a processor causes the processor to implement any of aspects 1 to 15.

Aspect 19 is a method of wireless communication at a wireless device, including receiving a targeted SI update indication for one or more subsets of wireless devices including the wireless device from a network node, the targeted SI update indication including a downlink grant of at least one SI update associated with the one or more subsets of wireless devices of a set of wireless devices, and receiving the at least one SI update from the network node based on the downlink grant of the at least one SI update associated with the one or more subsets of wireless devices including the wireless device.

Aspect 20 is the method of aspect 19, where the targeted SI update indication includes an indicator that the targeted SI update indication is associated with the one or more subsets of wireless devices including the wireless device, and where the targeted SI update indication is received in DCI 1_0 scrambled with a P-RNTI.

Aspect 21 is the method of aspect 20, where at least one of a short message indicator of the DCI 1_0 or at least one bit of a short message of the DCI 1_0 is the indicator that the targeted SI update indication is associated with the one or more subsets of wireless devices including the wireless device.

Aspect 22 is the method of aspect 21, where reserved bits of the short message of the DCI 1_0 includes a bitmap indicating the one or more subsets of wireless devices associated with the targeted SI update indication, and a presence of the bitmap in the reserved bits of the short message of the DCI 1_0 is the indicator that the targeted SI update indication is associated with the one or more subsets of wireless devices including the wireless device.

Aspect 23 is the method of any of aspects 21 and 22, where the short message indicator of the DCI 1_0 is the indicator that the targeted SI update indication is associated with the one or more subsets of wireless devices including the wireless device, where the short message of the DCI 1_0 includes a bitmap indicating the one or more subsets of wireless devices associated with the targeted SI update indication.

Aspect 24 is the method of any of aspects 21 to 23, where the P-RNTI is a P2_RNTI associated with the one or more subsets of wireless devices including the wireless device, and the P2-RNTI is the indicator that the targeted SI update indication is associated with the one or more subsets of wireless devices including the wireless device, and where a short message of the DCI 1_0 scrambled with the P2-RNTI includes a bitmap indicating the one or more subsets of wireless devices associated with the targeted SI update indication.

Aspect 25 is the method of any of aspects 21 to 24, where at least one reserved bit of the DCI 1_0 is the indicator that the targeted SI update indication is associated with the one or more subsets of wireless devices including the wireless device, where the at least one processor is further configured to receive an identification of the one or more subsets of wireless devices associated with the targeted SI update indication.

Aspect 26 is the method of aspect 25, where the identification of the one or more subsets of wireless devices associated with the targeted SI update indication is received in at least one of a second DCI 1_0 scrambled with a P2_RNTI associated with the one or more subsets of wireless devices including the wireless device, a short message of the second DCI 1_0 including a bitmap indicating the one or more subsets of wireless devices associated with the targeted SI update indication, or a downlink payload associated with the downlink grant of the SI in the targeted SI update indication, the downlink payload including the bitmap indicating the one or more subsets of wireless devices associated with the targeted SI update indication.

Aspect 27 is the method of any of aspects 19 to 26, further including receiving a configuration or a reconfiguration of the association between the targeted SI update indication and the one or more subsets of wireless devices including the wireless device, where the targeted SI update indication is received from the network node based on the configuration or the reconfiguration of the association between the targeted SI update indication and the one or more subsets of wireless devices including the wireless device.

Aspect 28 is the method of any of aspects 19 to 27, further including receiving a notice that the network node supports the targeted SI update indication for the one or more subsets of wireless devices from the network node, or transmitting capabilities of the one or more subsets of wireless devices to support the targeted SI update indication including a downlink grant of the at least one SI update associated with the one or more subsets of wireless devices, where the targeted SI update indication is received from the network node based on the notice that the network node supports the targeted SI update indication for the one or more subsets of wireless devices or the capabilities of the wireless device transmitted to the network node.

Aspect 29 is the method of any of aspects 19 to 28, further including receiving an instruction of a wireless device's behavior to either (A) monitor for DCI 1_0 scrambled with a common P-RNTI and DCI 1_0 scrambled with a P2_RNTI, the common P-RNTI associated with a set of wireless devices, or (B) monitor for DCI 1_0 scrambled with the P2-RNTI.

Aspect 30 is the method of aspect 29, further including receiving a notice that the network node supports instructing the wireless device's behavior, or transmitting a capability of the wireless device to support the wireless device's behavior, where the wireless device's behavior is instructed based on the capability of the wireless devices.

Aspect 31 is the method of any of aspects 19 to 30, where the targeted SI update indication for the one or more subsets of wireless devices is received in a PDSCH or a dedicated group-common PDCCH.

Aspect 32 is an apparatus for wireless communication including at least one processor coupled to a memory and configured to implement any of aspects 19 to 31, further including a transceiver coupled to the at least one processor.

Aspect 33 is an apparatus for wireless communication including means for implementing any of aspects 19 to 31.

Aspect 34 is a non-transitory computer-readable medium storing computer executable code, where the code when executed by a processor causes the processor to implement any of aspects 19 to 31.

What is claimed is:

1. An apparatus for wireless communication at a network node, comprising:
a memory; and
at least one processor coupled to the memory and configured to:
obtain at least one update of a system information (SI) associated with one or more subsets of wireless devices among a set of wireless devices associated with the network node or a subset of directions from the network node; and
output for transmission a targeted SI update indication for the one or more subsets of wireless devices among the set of wireless devices associated with the network node or for the subset of directions, the targeted SI update indication including a downlink grant of the at least one SI update associated with the one or more subsets of wireless devices or the subset of directions.

2. The apparatus of claim 1, further comprising a transceiver coupled to the at least one processor, and
wherein the at least on processor is further configured to output for transmission the at least one SI update for the one or more subsets of wireless devices based on the downlink grant of the at least one SI update associated with the one or more subsets of wireless devices,
wherein the subset of wireless devices includes at least one of a user equipment or a child integrated access and backhaul (IAB) node.

3. The apparatus of claim 1, wherein the targeted SI update indication is for the subset of directions and is output for transmission in the subset of directions.

4. The apparatus of claim 1, wherein the targeted SI update indication includes an indicator that the targeted SI update indication is associated with the one or more subsets of wireless devices,
wherein the targeted SI update indication is output for transmission in downlink control information (DCI) format 1_0 (DCI 1_0) scrambled with a paging radio network temporary identifier (P-RNTI).

5. The apparatus of claim 4, wherein at least one of a short message indicator of the DCI 1_0 or at least one bit of a short message of the DCI 1_0 is the indicator that the targeted SI update indication is associated with the one or more subsets of wireless devices.

6. The apparatus of claim 5, wherein reserved bits of the short message of the DCI 1_0 includes a bitmap indicating the one or more subsets of wireless devices associated with the targeted SI update indication, and a presence of the bitmap in the reserved bits of the short message of the DCI 1_0 is the indicator that the targeted SI update indication is associated with the one or more subsets of wireless devices.

7. The apparatus of claim 5, wherein the short message indicator of the DCI 1_0 is the indicator that the targeted SI update indication is associated with the one or more subsets of wireless devices, wherein the short message of the DCI 1_0 includes a bitmap indicating the one or more subsets of wireless devices associated with the targeted SI update indication.

8. The apparatus of claim 4, wherein the P-RNTI is a dedicated P-RNTI (P2-RNTI) associated with the one or more subsets of wireless devices, and the P2-RNTI is the indicator that the targeted SI update indication is associated with the one or more subsets of wireless devices,
wherein a short message of the DCI 1_0 scrambled with the P2-RNTI includes a bitmap indicating the one or more subsets of wireless devices associated with the targeted SI update indication.

9. The apparatus of claim 4, wherein at least one reserved bit of the DCI 1_0 is the indicator that the targeted SI update indication is associated with the one or more subsets of wireless devices, wherein the at least one processor is further configured to output for transmission an identification of the one or more subsets of wireless devices associated with the targeted SI update indication.

10. The apparatus of claim 9, wherein the identification of the one or more subsets of wireless devices associated with the targeted SI update indication is output for transmission in at least one of a second DCI 1_0 scrambled with a dedicated P-RNTI (P2-RNTI) associated with the one or more subsets of wireless devices, a short message of the second DCI 1_0 including a bitmap indicating the one or more subsets of wireless devices associated with the targeted SI update indication, or a downlink payload associated with the downlink grant of the SI in the targeted SI update indication, the downlink payload including the bitmap indicating the one or more subsets of wireless devices associated with the targeted SI update indication.

11. The apparatus of claim 1, wherein the at least one processor is further configured to:
output for transmission a configuration or a reconfiguration of the association between the targeted SI update indication and the one or more subsets of wireless devices, wherein the targeted SI update indication is output for transmission for the one or more subsets of wireless devices based on the configuration or the reconfiguration of the association between the targeted SI update indication and the one or more subsets of wireless devices.

12. The apparatus of claim 1, wherein the at least one processor is further configured to:
output for transmission a notice that the network node supports the targeted SI update indication for the one or more subsets of wireless devices, or
obtain capabilities of the one or more subsets of wireless devices to support the targeted SI update indication including a downlink grant of the at least one SI update associated with the one or more subsets of wireless devices,
wherein the targeted SI update indication is output for transmission for the one or more subsets of wireless devices based on the notice that the network node supports the targeted SI update indication for the one or more subsets of wireless devices or the obtained capabilities of the one or more subsets of wireless devices.

13. The apparatus of claim 1, wherein the at least one processor is further configured to:
instruct the one or more subsets of wireless devices' behavior to either (A) monitor for downlink control information (DCI) format 1_0 (DCI 1_0) scrambled with a common paging radio network temporary identifier (P-RNTI) and DCI 1_0 scrambled with a dedicated P-RNTI (P2-RNTI), the common P-RNTI associated with the set of wireless devices, or (B) monitor for downlink control information (DCI) format 1_0 (DCI 1_0) scrambled with the P2-RNTI.

14. The apparatus of claim 13, wherein the at least one processor is further configured to:
output for transmission a notice that the network node supports instructing the one or more subsets of wireless devices' behavior, or
obtain capabilities of the one or more subsets of wireless devices to support the one or more subsets of wireless devices' behavior,
wherein the one or more subsets of wireless devices' behavior is instructed based on the obtained capabilities of the one or more subsets of wireless devices.

15. The apparatus of claim 1, wherein the targeted SI update indication for the one or more subsets of wireless devices is output for transmission in a physical downlink shared channel (PDSCH) or a dedicated group-common physical downlink control channel (PDCCH).

16. An apparatus for wireless communication at a wireless device, comprising:
a memory; and
at least one processor coupled to the memory and configured to:
receive a targeted system information (SI) update indication for one or more subsets of wireless devices including the wireless device from a network node, the targeted SI update indication including a downlink grant of at least one SI update associated with the one or more subsets of wireless devices of a set of wireless devices; and
receive the at least one SI update from the network node based on the downlink grant of the at least one SI update associated with the one or more subsets of wireless devices including the wireless device.

17. The apparatus of claim 16, further comprising a transceiver coupled to the at least one processor,
wherein the targeted SI update indication includes an indicator that the targeted SI update indication is associated with the one or more subsets of wireless devices including the wireless device,
wherein the targeted SI update indication is received in downlink control information (DCI) format 1_0 (DCI 1_0) scrambled with a paging radio network temporary identifier (P-RNTI).

18. The apparatus of claim 17, wherein at least one of a short message indicator of the DCI 1_0 or at least one bit of a short message of the DCI 1_0 is the indicator that the targeted SI update indication is associated with the one or more subsets of wireless devices including the wireless device.

19. The apparatus of claim 18, wherein reserved bits of the short message of the DCI 1_0 includes a bitmap indicating the one or more subsets of wireless devices associated with the targeted SI update indication, and a presence of the bitmap in the reserved bits of the short message of the DCI 1_0 is the indicator that the targeted SI update indication is associated with the one or more subsets of wireless devices including the wireless device.

20. The apparatus of claim 18, wherein the short message indicator of the DCI 1_0 is the indicator that the targeted SI update indication is associated with the one or more subsets of wireless devices including the wireless device, wherein the short message of the DCI 1_0 includes a bitmap indicating the one or more subsets of wireless devices associated with the targeted SI update indication.

21. The apparatus of claim 18, wherein the P-RNTI is a dedicated P-RNTI (P2-RNTI) associated with the one or more subsets of wireless devices including the wireless device, and the P2-RNTI is the indicator that the targeted SI update indication is associated with the one or more subsets of wireless devices including the wireless device,
wherein a short message of the DCI 1_0 scrambled with the P2-RNTI includes a bitmap indicating the one or more subsets of wireless devices associated with the targeted SI update indication.

22. The apparatus of claim 18, wherein at least one reserved bit of the DCI 1_0 is the indicator that the targeted SI update indication is associated with the one or more subsets of wireless devices including the wireless device, wherein the at least one processor is further configured to receive an identification of the one or more subsets of wireless devices associated with the targeted SI update indication.

23. The apparatus of claim 22, wherein the identification of the one or more subsets of wireless devices associated with the targeted SI update indication is received in at least one of a second DCI 1_0 scrambled with a dedicated P-RNTI (P2-RNTI) associated with the one or more subsets of wireless devices including the wireless device, a short message of the second DCI 1_0 including a bitmap indicating the one or more subsets of wireless devices associated with the targeted SI update indication, or a downlink payload associated with the downlink grant of the SI in the targeted SI update indication, the downlink payload including the bitmap indicating the one or more subsets of wireless devices associated with the targeted SI update indication.

24. The apparatus of claim 16, wherein the at least one processor is further configured to:
receive a configuration or a reconfiguration of the association between the targeted SI update indication and the one or more subsets of wireless devices including the wireless device, wherein the targeted SI update indication is received from the network node based on the configuration or the reconfiguration of the association between the targeted SI update indication and the one or more subsets of wireless devices including the wireless device.

25. The apparatus of claim 16, wherein the at least one processor is further configured to:
receive a notice that the network node supports the targeted SI update indication for the one or more subsets of wireless devices from the network node, or
transmit capabilities of the one or more subsets of wireless devices to support the targeted SI update indication including a downlink grant of the at least one SI update associated with the one or more subsets of wireless devices,
wherein the targeted SI update indication is received from the network node based on the notice that the network node supports the targeted SI update indication for the one or more subsets of wireless devices or the capabilities of the wireless device transmitted to the network node.

26. The apparatus of claim 16, wherein the at least one processor is further configured to:
receive an instruction of a wireless device's behavior to either (A) monitor for downlink control information (DCI) format 1_0 (DCI 1_0) scrambled with a common paging radio network temporary identifier (P-RNTI) and DCI 1_0 scrambled with a dedicated P-RNTI (P2-RNTI), the common P-RNTI associated with a set of wireless devices, or (B) monitor for downlink control information (DCI) format 1_0 (DCI 1_0) scrambled with the P2-RNTI.

27. The apparatus of claim 26, wherein the at least one processor is further configured to:
receive a notice that the network node supports instructing the wireless device's behavior, or
transmit a capability of the wireless device to support the wireless device's behavior,
wherein the wireless device's behavior is instructed based on the capability of the wireless devices.

28. The apparatus of claim 16, wherein the targeted SI update indication for the one or more subsets of wireless devices is received in a physical downlink shared channel (PDSCH) or a dedicated group-common physical downlink control channel (PDCCH).

29. A method of wireless communication at a network node, comprising:
obtaining at least one update of a system information (SI) associated with one or more subsets of wireless devices among a set of wireless devices associated with the network node or a subset of directions from the network node; and
outputting for transmission a targeted SI update indication for the one or more subsets of wireless devices among the set of wireless devices associated with the network node or for the subset of directions, the targeted SI update indication including a downlink grant of the at least one SI update associated with the one or more subsets of wireless devices or the subset of directions.

30. A method of wireless communication at a network device, comprising:
receiving a targeted system information (SI) update indication for one or more subsets of wireless devices including the wireless device from a network node, the targeted SI update indication including a downlink grant of at least one SI update associated with the one or more subsets of wireless devices of a set of wireless devices; and
receiving the at least one SI update from the network node based on the downlink grant of the at least one SI update associated with the one or more subsets of wireless devices including the wireless device.
